(19) United States
(12) Patent Application Publication
(10) Pub. No.: US 2006/0224500 A1
(43) Pub. Date: Oct. 5, 2006

(54) System and method for creating risk profiles for use in managing operational risk

(76) Inventors: Kevin Stane, Charlotte, NC (US); Dawn Connell, Waxhaw, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/095,913

(22) Filed: Mar. 31, 2005

(51) Int. Cl. G06Q 40/00

(52) U.S. Cl. 705/38

(57) ABSTRACT

A computer-based system and method, a computer readable medium comprising software, and a data structure for creating a risk profile for a business unit of an enterprise for use in managing operational risk.

### CROSS REFERENCE TO RELATED APPLICATION

This application is related to U.S. application Ser. No. ______, entitled System and Method For Collecting Operational Loss Data For Operational Risk Management, which is being filed simultaneously herewith, the contents of which are incorporated herein by reference.

A portion of this disclosure contains material that is subject to copyright protection. The copyright owner consents to the reproduction of the disclosure, as it appears in the Patent and Trademark Office patent files or records, but otherwise reserves all copyright rights whatsoever.

### FIELD OF THE INVENTION

The present invention generally relates to a computer-based system and method, a computer readable medium containing computer software, and a data structure for creating risk profiles for various business units of a enterprise for use in managing operational risk.

### BACKGROUND OF THE INVENTION

Operational risk may be thought of as the risk of loss resulting from inadequate or failed internal processes, people, systems, or from external events. Operational risk may include legal risk, but typically excludes credit risk, business (or strategic) risk and reputation risk. Credit risk may be thought of as the risk to earnings or capital arising from an obligor's failure to meet the terms of any contract with a business enterprise, such as financial institution, or otherwise failure to perform as agreed. Credit risk may be present in business activities where the outcome depends on another party's performance. Market risk, however, may be thought of as the risk of value deterioration and/or losses in an enterprise's on-and off-balance sheet positions due to adverse market moves against its holdings. Consequences of market risk may include diminished liquidity and financial losses. Finally, business risk (or strategic risk) may be thought of as potential losses a business unit may incur that is not a credit, market or operational risk. An example of a strategic risk may be a loss resulting from a flawed business model or a changing economic environment.

Typically, market or credit risk losses that include an operational loss component will not be categorized as operational risk losses for regulatory capital allocation purposes. Nevertheless, business enterprises may desire to track such losses meeting a predefined materiality threshold in an operational loss database. Such loss data may be segregated, however, from losses used for operational risk capital allocation purposes.

As can be appreciated, management of operational risk makes good business sense and gives a business enterprise competitive advantages, such as improved operational sophistication, speed and execution, improved customer experience, regulatory compliance, increased profits, the ability to invest excess capital, lower borrowing costs, reduced earnings volatility, higher valuation, and increased shareholder value. In addition, effective operational risk management of a financial institution may facilitate compliance with evolving regulatory requirements regarding operational risk, thereby allowing the financial institution to allocate lower levels of operational risk capital.

Therefore, what is needed is an operational risk management framework that provides a consistent and comprehensive operational risk management approach across a business enterprise, such as a financial institution. More particularly, what is needed is a system and method for managing operational risk using risk profiles. Even more particularly, what is needed is a consistent, structured approach, for creating risk profiles for the various business units of a enterprise, so that the individual risk profiles may be considered in aggregate and used to develop an enterprise-wide risk profile.

### BRIEF DESCRIPTION OF THE DRAWINGS

FIG. 1 illustrates an exemplary embodiment of the system of the present invention.

FIG. 2 illustrates an exemplary process for creating a risk profile.

FIG. 3 illustrates an exemplary data structure for storing information relating to a risk profile.

FIGS. 4A-E illustrate exemplary user interfaces to a process for creating a Control Environment Matrix.

FIGS. 5A-F illustrate exemplary user interfaces to a process for creating a Control Environment Matrix.

FIG. 6 illustrates an exemplary user interface to a process for creating a summary of control environment rating and residual risk rating information.

FIGS. 7A-7E illustrate exemplary operational loss event types.

### DETAILED DESCRIPTION OF PREFERRED EMBODIMENTS

Reference will now be made in detail to the presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention cover such modifications and variations as come within the scope of the appended claims and their equivalents.

Also, as can be appreciated, the processing logic of the invention can be implemented with either software or hardware, or a combination of the two. That is, the specification provides sufficient information to those skilled in the art to implement the invention using one or more general purpose computers programmed with software, and/or one or more specialized devices using discrete circuitry.

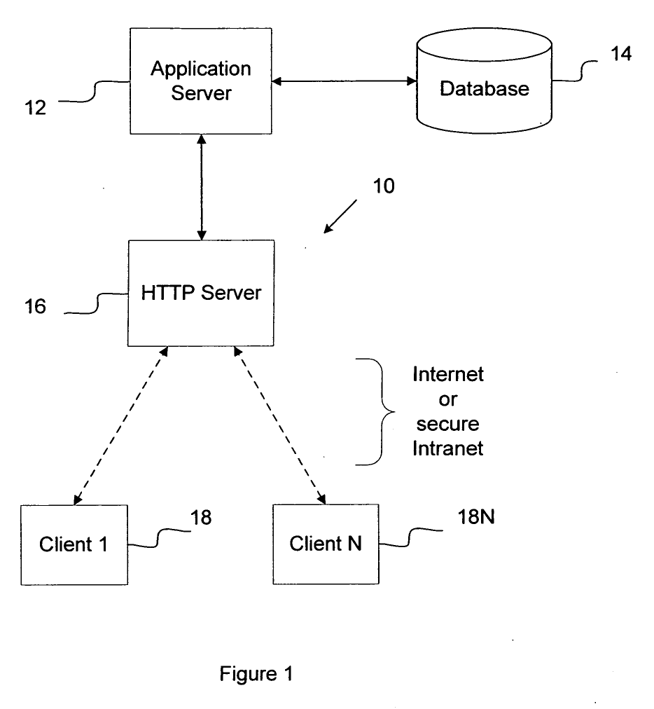

FIG. 1 illustrates an exemplary embodiment of the system 10 of the present invention. The exemplary embodiment described is a client-server web application that uses HTTP as its transport protocol. Multiple remote clients may access the system via a web browser. The system may authenticate users and encrypt data via secure sockets or VPN tunnels, for example. While a client-server web application is one exemplary embodiment of the invention, as those skilled in the art can appreciate, the invention is not limited to the use of client-server architecture, and other software architectures are within the scope of the present invention.

The system 10 may includes the following components: an application server 12, a database 14, an HTTP server 16, and one or more clients 18-18N in electronic communication with the HTTP server 16 via an open communications network such as the Internet, or via a secure intranet.

Overview of Operational Risk Management

As an overview, collecting and categorizing operational loss data may be an initial step in a comprehensive operational risk management framework. Categorizing operational loss data may include associating operational loss data with one or more operational loss events. After operational loss data is collected and categorized, the operational loss information may be used to assess a business unit's operational risks and risk controls. Such an assessment, in turn, may be used to develop a risk profile for a business unit, which may include an assessment of a business unit's current risk control environment and its residual, i.e., future, risks. The process of developing a risk profile for a business unit, for example, may involve both analyzing past events and considering future operational risks so as to fully appreciate its operational risk management strengths and weaknesses. A risk profile may be used to establish actions to improve the management of a business unit's operational risk. In addition, a risk profile may be used in determining the amount of operational risk capital to be allocated to a business unit to comply with regulatory requirements, such as those imposed on a bank, for example. Operational loss information also may be used to generate reports for operational risk management personnel.

An effective operational risk management framework may be implemented using a computer-based operational risk information and management system. One suitable system is available from Centerprise Services, Inc. of Purchase, New York. As can be appreciated, however, other operational risk information and management systems may be used without departing from the scope and spirit of the invention. Functions that may be performed by operational risk information and management systems include loss data collection and categorization, control self-assessments, risk profiling, and issue/action plan management. The present invention is directed to a process for creating a risk profile for a business unit of an enterprise.

Overview of Risk Profile Creation Process

A risk profile may be thought of as a combination of a control environment rating and residual risk rating for a business unit. Such ratings for a business unit may be determined by operational risk management personnel for that business unit.

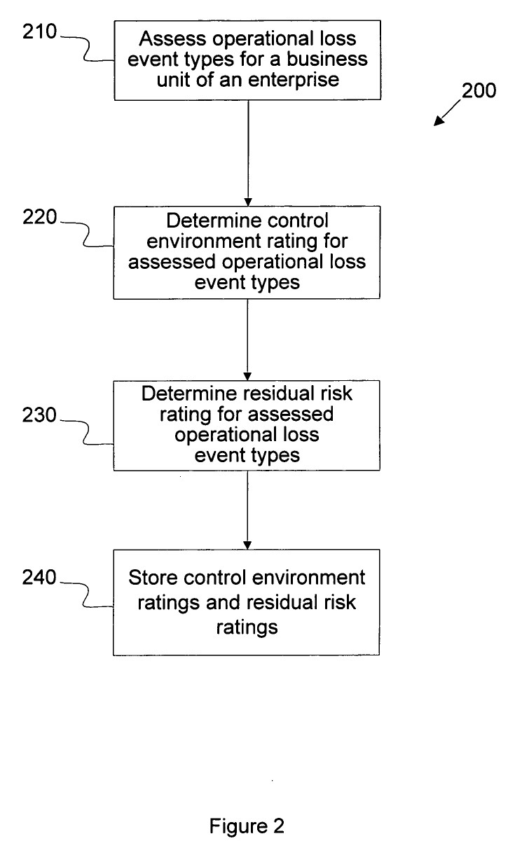

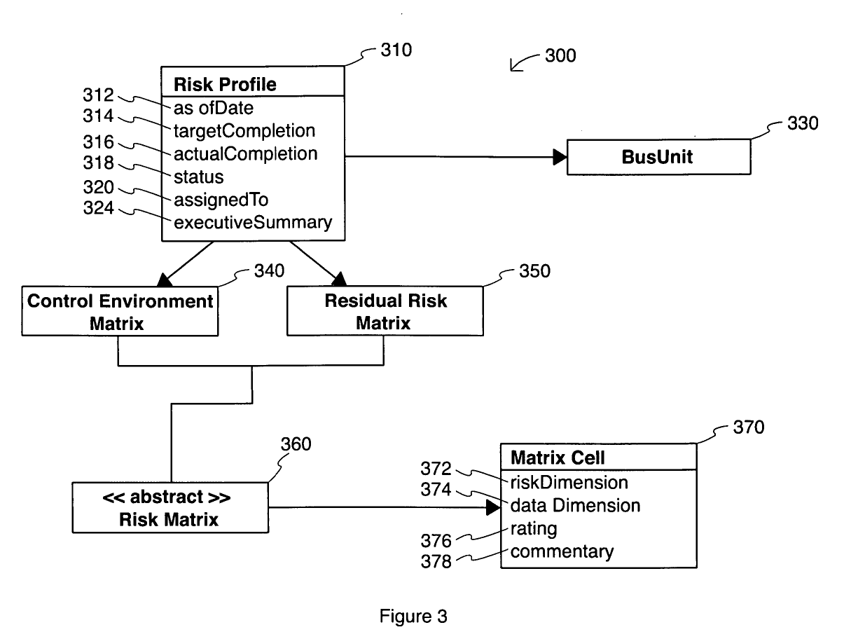

An exemplary risk profile creation process 200 is illustrated by FIG. 2. As can be seen from FIG. 2, process 200 may be begin with assessing a plurality of operational loss event types for a business unit of an enterprise (block 210). Operational risk management personnel may review the assessment data and determine a control environment rating for the business unit based on the assessment of the plurality of operational loss event types for a business unit of an enterprise (block 220). Operational risk management personnel may also determine a residual risk rating for the business unit based on the assessment of the plurality of operational loss event types for a business unit of at data (block 230). The control environment rating and residual risk rating information may be stored (block 240.) An exemplary data structure for storing the control environment rating and residual risk rating information is illustrated in FIG. 3.

Alternatively, the process may include an assessment of a plurality of functional risk areas for a business unit, determining control environment and residual risk ratings for the assessed plurality of functional risk areas, and storing the control environment rating and residual risk rating information.

A control environment rating may be thought of as a business unit's historical risk profile while a residual risk rating may be thought of as a business unit's future risk profile. Determining a control environment rating may include determining ratings for a business unit's loss history, issues and risk and controls assessment. Determining a residual risk rating may include determining a scenario analysis rating, as well as ratings for customer impact and reputational impact. Both the control environment rating and the residual risk rating may include ratings for one or more loss event types, such as Basel Level 1 loss event types and/or Basel Level 2 loss event types.

After control environment ratings and residual risk ratings have been determined for one or more lower level loss event types, such as Basel Level 2 loss event types, summary control environment ratings and summary residual risk ratings may be determined, based on the control environment ratings and residual risk ratings, for one or more upper level loss events, such as Basel Level 1 loss event types. The process for determine ratings will be discussed in more detail below. The ratings may then be submitted to operational risk management and/or business unit management personnel for review and approval.

Risk profiles for an enterprise's various business units may be aggregated and used as input to the determination of a risk profile for an entire the enterprise or some part thereof.

Creating a Risk Profile (Shell)

A risk profile file (or shell) may be created before a control environment rating or residual risk rating can be determined for a business unit. A graphical user interface (not shown) may be provided to facilitate the process of creating a risk profile file. A risk profile may be created for a point-in-time. An exemplary data structure 300 for storing information relating to a risk profile is illustrated by FIG. 3.

As shown in FIG. 3, a risk profile may include the following data elements: a Risk Profile element 310, a BusUnit element 330, a Control Environment Matrix element 340, a Residual Risk Matrix element 350, Risk Matrix element 360 and a Matrix Cell element 370. A Risk Profile element 310 may include the following fields of information: a Risk Profile As Of Date field 312, which is the date as of which a control environment and residual risk will be assessed; a Target Completion Date field 314, which is a target date the risk profile is to be completed; a Status field 316; an Assigned To field 318, which is a person that is responsible for completing the risk profile, typically, business unit and/or operational risk management personnel; and an Executive Summary field 320. A Matrix Cell element 370 may include the following fields of information: a Risk Dimension field 372, a Data Dimension field 374, a Rating field 376 and a Commentary field 378. As can be appreciated, a Matrix Cell may represent a cell within an Control Environment Matrix or a Residual Risk Matrix. A Risk Dimension field 372 may include a risk dimension such as a loss event type or a functional risk area. A Data Dimension field 374 may include, for example, loss data. A Rating field 376 may include a rating for a particular risk dimension, and a Commentary field 378 may include information about a particular rating for a particular risk dimension.

Additional fields of information that may be included in a risk profile file may be a Risk Profile Name field, which may be the name of the risk profile; and a Description field, which may be used to provide additional information about the risk profile. A Status field also may be provided, which indicates the status of the risk profile. Upon entry and storage of information stored in a Risk Profile element 310 and a BusUnit element 320, a risk profile file will have been created.

After a risk profile file has been created and stored, a process to edit a risk profile may be provided, whereby certain of the fields of information provided via the process of creating a risk profile file may be edited. A graphical user interface (not shown) may be provided to facilitate the process of editing a risk profile file. An edit risk profile process may be configured to prevent the editing of a Bus Unit field and a Risk Profile As Of Date field.

A process also may be provided for deleting a risk profile. A graphical user interface (not shown) may be provided to facilitate the process of deleting a risk profile file. The delete risk profile process may be configured so as to only allow risk profiles with a Status value of Pending may be deleted. If a risk profile has a Status value of Ready, which may mean the value stored in the Risk Profile As Of Date field has passed, the delete risk profile process can be configure to prohibit the deletion of that risk profile, although the process may be configured to allow system administration personnel to delete such a risk profile.

Completing a Risk Profile

To facilitate the process of completing a risk profile, a complete risk profile process may be provided. The process of completing a risk profile may include a process for determining a control environment rating and a process for determining a residual risk rating, both of which are discussed in more detail below.

The process for completing a risk profile may include a graphical user interface (not shown) for selecting a risk profile to be completed. The user interface may include a first area for displaying the information about the risk profile that was entered via a create risk profile process. The user interface may include a second area for displaying one or more processes that may be performed to complete a risk profile. The processes may be displayed in a preferred order for completing a risk profile. The processes that may be available may depend on the status of a risk profile. The availability of a process may be indicated by the presence or absence of a hyperlink, which, if present and selected, would initiate the corresponding process. The status of a risk profile may depend on the part or parts of the risk profile that have been completed. For example, if a user has started the process of completing a risk profile, but stopped before completing the process, the system may be configured to allow a user to edit information entered via any of the processes that were previously initiated. The user interface may also include a third area for displaying one or more administrative processes that may be used to populate a risk profile with information from other data stores containing risk management information. Such administrative processes may be executed before the process of completing a risk profile is initiated. Such administrative processes may include an Update Loss Data process. An Update Loss Data process may cause the system to searches for information relating to operational losses and, perhaps, associated loss events. Other administrative process that may be provided may include an Update Issues process and an Update Risk Assessment process.

After causing such administrative processes to be performed, a user may continue the process of completing the risk profile by initiating one of the processes displayed in the second area of the user interface. As mentioned above, processes that are available and that are displayed as such in the second area are based on the Status of the risk profile. If none of the processes displayed in the second area have been completed, only two processes that may be available, namely, an Edit Control Environment Matrix process and a Generate Workshop Planning Report process.

Generate Workshop Planning Report

A process for generating a Workshop Planning Report may be provided to facilitate the process of completing a risk profile. Initiating a Generate Workshop Planning Report process will cause a Workshop Planning Report to be displayed. A Workshop Planning Report may include a first section for displaying descriptive information about a risk profile, e.g., Name, Business Unit, As Of Date. A Workshop Planning Report may include a second section for displaying operational loss information. Operational loss information displayed via a Workshop Planning Report may include, for each Basel Level 2 loss event type, information about 1) Risk Assessment, 2) Issues, and 3) Loss Data.

The information about Risk Assessment displayed via a Workshop Planning Report may include details of risk control assessment surveys and corresponding ratings therefor. Specifically, a Workshop Planning Report may display, for each Basel Level 2 loss event type, a specific risk control and a rating of that control. The Workshop Planning Report also may display information about a risk assessment summary rating. Risk control and/or risk assessment summary ratings may include Satisfactory, Needs Improvement and Unsatisfactory.

A process for risk control assessment may have an objective of identifying risks and assessing, testing, and documenting related controls. Risk control assessment may be performed for business units and/or functional risk areas. For purposes of risk control assessment, a risk may be thought of as the possibility of incurring a loss, which may be cause by inadequate or failed processes, people or systems or from external events. A control may be thought of as a process, procedure or action intended to mitigate a risk and/or minimize the effects of a risk. Risk control assessment may encompass significant enterprise-wide risks that may have a material impact on the enterprise. For purposes of risk control assessment, a material impact may be thought of as higher earnings volatility, lower customer satisfaction or damage to an enterprise's reputation.

A risk control assessment process may include three phases, namely, 1) program development, 2) survey creation, administration and completion, and 3) reporting, each of which will be discussed in more detail below.

Program development may be thought of as a process of identifying risk and control criteria to be used in a risk control assessment survey. Each functional risk area may be responsible for developing enterprise-wide risk and control criteria. In addition, business units may have the option of developing business unit specific risk and control criteria.

Programs may be grouped into one of four specific program families, namely, 1) functional risk area standard programs, which may be programs created by a functional risk area that may be deployed throughout an enterprise; 2) business unit programs, which may be programs that related to a specific business unit's risks and controls; 3) business environment programs, which may be programs that focus on expected business environment changes, e.g., personnel turnover, new products, merger and acquisitions; and 4) detailed risk assessments, which may be programs developed and used throughout an enterprise.

A program development process may begin with identifying a comprehensive set of significant risks by examining potential for failures of people, processes or systems in their respective functional risk areas. Significant risks may be thought of as risks with high inherent impact across the enterprise. Each of the significant risks identified may be assigned to a corresponding loss event type, a Basel Level 2 loss event type, for example. Mitigating controls may also be identified, along with the control criteria and testing requirements. Each mitigating control may be assigned a control type and category. Once the content of a risk control assessment has been developed by one or more functional risk areas and/or business units, operational risk management personnel may review the various risk control assessments to eliminate overlaps and to ensure consistency in scope, language, coverage and materiality.

In order to identify risks and control standards for an functional risk area program, a gap analysis may be performed. The gap analysis may include identifying significant risks, determining minimum standards needed to adequately manage the identified risks, determining current mitigation controls, identifying gaps between current mitigation controls and a desired risk environment, and developing one or more action plans, which may include due dates, action owners, and status updates, to achieve the desired risk environment.

After risk and control standards have been identified, they may be documented and classified into one of three categories according to their effectiveness. Categories may include 1) weak controls, which represents risks that have no or few controls to mitigate the risk; a high level of residual risk may result from a weak control; 2) moderate controls, which represent risks that have some controls, but that are not sufficient to achieve a desired risk environment; moderate controls may result in a medium level of residual risk; and 3) strong controls, which represents risks meeting minimum control standards identified during a functional risk gap analysis. Such a categorization of risk and controls may define a desired risk environment and a level of residual risk.

With respect to survey creation, administration and completion, a survey may be thought of as an actual assessment of risks and controls as specified in one or more functional risk area and/or business unit programs. Business unit management personnel may select appropriate business unit personnel to complete the assessment. A survey may be administered using functionalities available in an operational risk management information system.

A risk control assessment process may include determining the program(s) that should be used in creating and completing a survey. A survey may then be created and completed. One or more employees may complete each of these steps. A survey for every functional risk area may be completed and a business unit survey and a business environment survey may be completed for each business unit that will complete a risk profile.

Before creating a survey, a business unit may have the option of establishing business unit specific risk criteria, which may provide the basis for assigning a risk exposure rating (e.g., Low, Moderate, or Significant) in a survey.

Surveys may be completed by business unit personnel that are familiar with a business unit's risks and control environment. The process of completing a survey may include determining if a risk is applicable to a business unit. If a risk is applicable, each control may be assessed by assigning a rating (e.g., unsatisfactory, needs improvement, satisfactory for the control based on the criteria defined in a survey. Other ratings may include meets standards, exceeds standards, or best practice. If control criteria is not applicable, a current control may be documented and a control score may be given. If control criteria are not provided for a business process, a current control must be documented and a control score must be given. Testing, if required, may be documented before a control assessment can be submitted. All controls may be assessed before a risk score (or rating) may be assigned. If a risk criteria is not defined for a business unit, the business unit may be unable to rate the risk for the business unit.

With respect to reporting, risk control assessment results may be stored in a risk control assessment data store and be an input to a business unit's risk profile. Survey responses can be aggregated and reported by business unit and/or by functional risk area. The effectiveness of a risk assessment process and its outputs may be assured by internal audit, which also may conduct independent testing and validation of controls surrounding the a risk control assessment process. A process for communication and issue escalation may be employed for escalation of potential gaps in loss data collection and/or risk control assessment.

Information about Issues displayed via a Workshop Planning Report may include the following fields of information: an Issue ID field, an Issue Title field, an Assigned To field, a Target Due Date field, a Status field and a Significance field. Values for the Significance field may include High, Medium and Low and may be based on the most significant open issue before the As-Of-Date for a particular loss event type. The displayed issues information may be based on issues and/or action plans that may have been previously identified, documented and stored by business unit management personnel, internal/external auditors and/or or external regulators. Such issues and/or action plans may be updated regularly, as additional operational risk issues may be identified and/or resolved. A process for identifying, documenting and storing information about issues may also facilitate communication of issues and/or action plans to relevant business unit and/or operational risk management personnel. The process may provide for escalation of issues and/or actions; the capture information and/or action plans at a business unit level, while storing such information in an enterprise-wide data store; and the development of action plans based on other related operational loss information. The process may provide for the capture information about operational loss issues from various sources and the may link the information capture from various sources together to form a common issue. The process also may allow for a business unit and/or individual to accept responsibility for a risk and to develop an action plan with milestones and/or deliverables. The process also may provide for assigning ownership for issues and/or action plans. The process may further provide that an issue may have multiple action plans, each of which may be assigned to one or more individuals, and that action plans have multiple milestones, each of which may also be assigned to one or more individuals. Business unit management personnel may decide whether to accept an assigned risk issue and document acceptance thereof. Business unit management personnel may be required to have operational risk management approval to close an issue. Issues may be identified and entered into an operational risk management information system by business unit personnel, and an issue may be assigned and action plans and/or milestones may be created at that time. On an ongoing basis, issues may be monitored and action plans may be tracked by an individual to whom the issue has been assigned, and/or or by business unit and/or operational risk management personnel.

Information about Loss Data displayed via a Workshop Planning Report may include information about direct losses related to a particular loss event type, including the a total amount of direct losses, a loss data rating, and information about one or more loss events. A loss data rating may be Low, Medium or High. Loss event information for each event displayed may include an Event ID, an Event Date, an Event Name, a Source (of the loss data), a Business Unit, and a Direct Loss Amount.

Information displayed via the Workshop Planning Report may be reviewed by appropriate operational risk management and/or business unit management personnel to confirm that the displayed loss data relates to the relevant business unit and is within the relevant time period.

Determining a Control Environment Rating

To facilitate the determination of a Control Environment rating for one or more loss event types, a process for creating a Control Environment Matrix may be provided. A Control Environment Matrix may be completed in three phases. A first phase may include entering workshop results. A second phase may include determining a Control Environment rating for one or more lower level loss event types, such as Basel Level 2 loss event types. A third phase may include determining a Control Environment rating for one or more upper level loss event types, such as Basel Level 1 loss event types. Each of these phases will be discussed in more detail below.

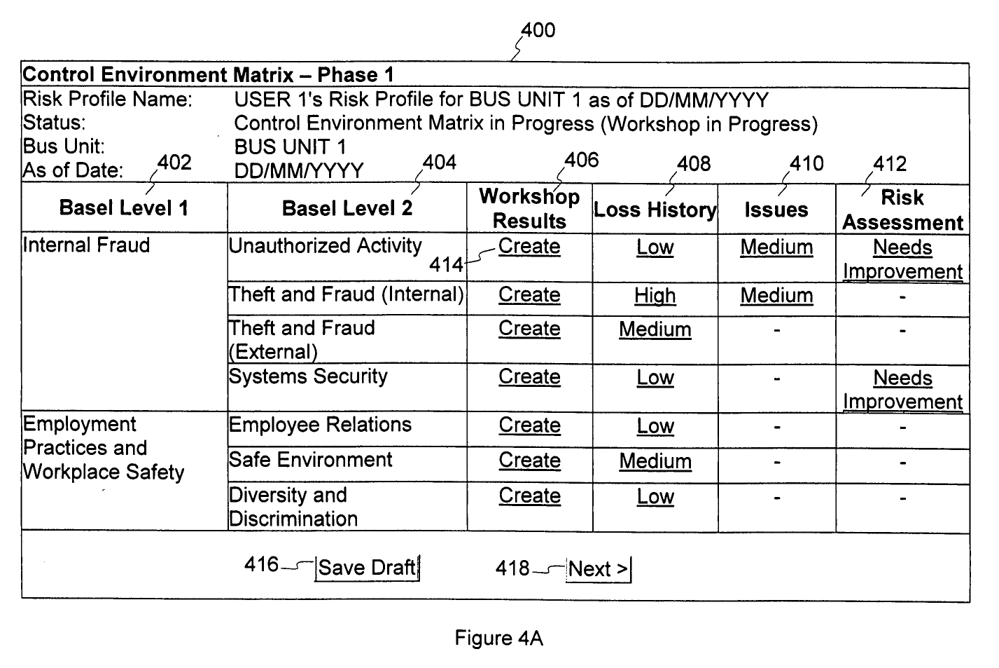

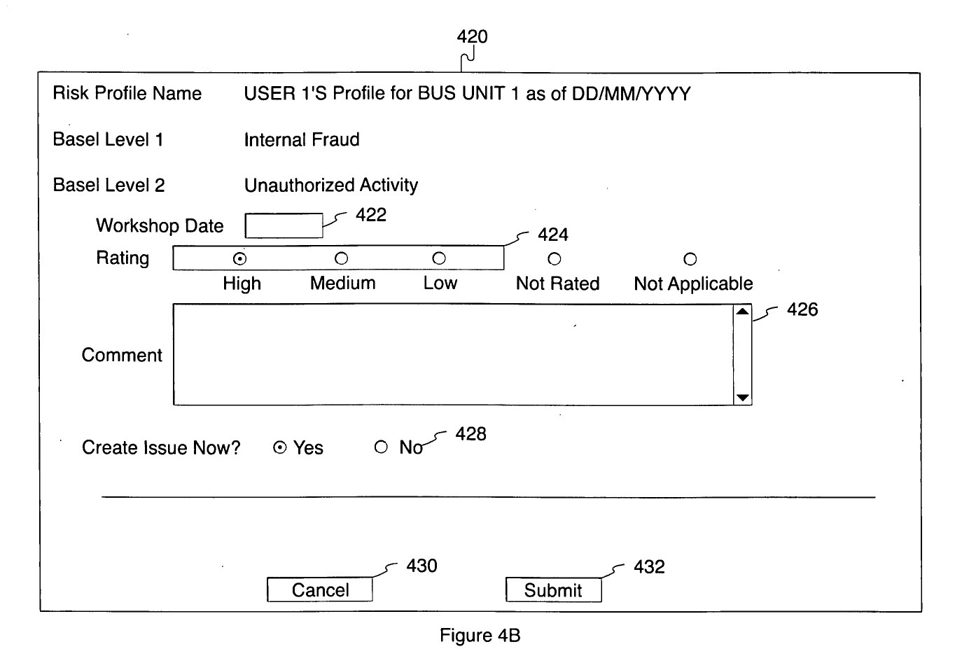

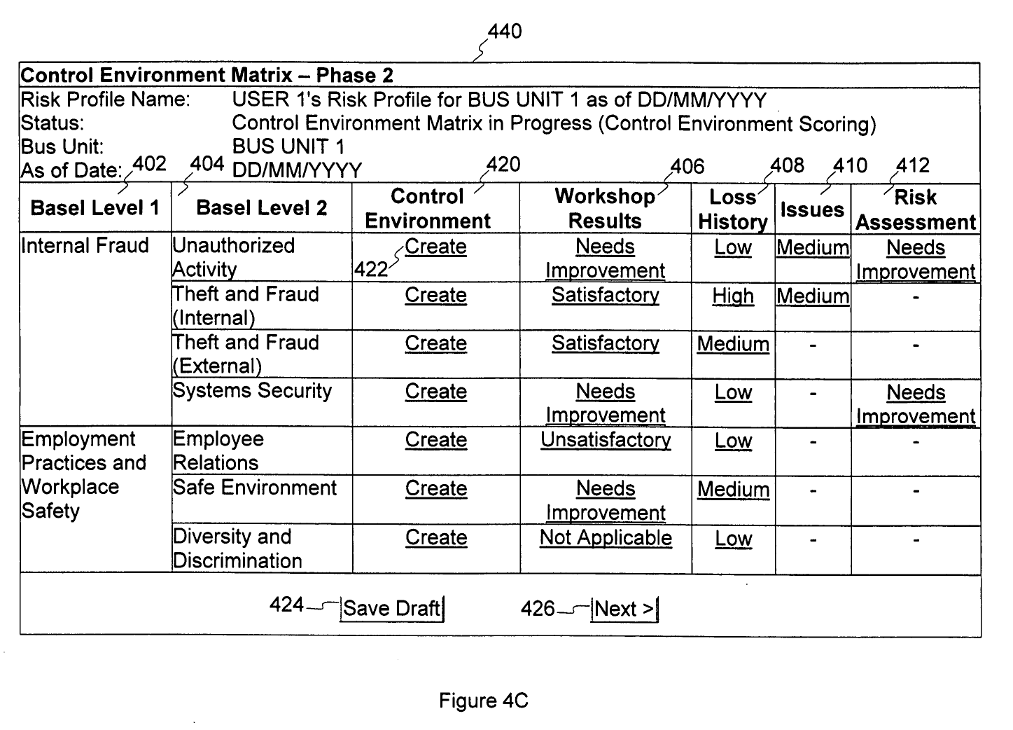

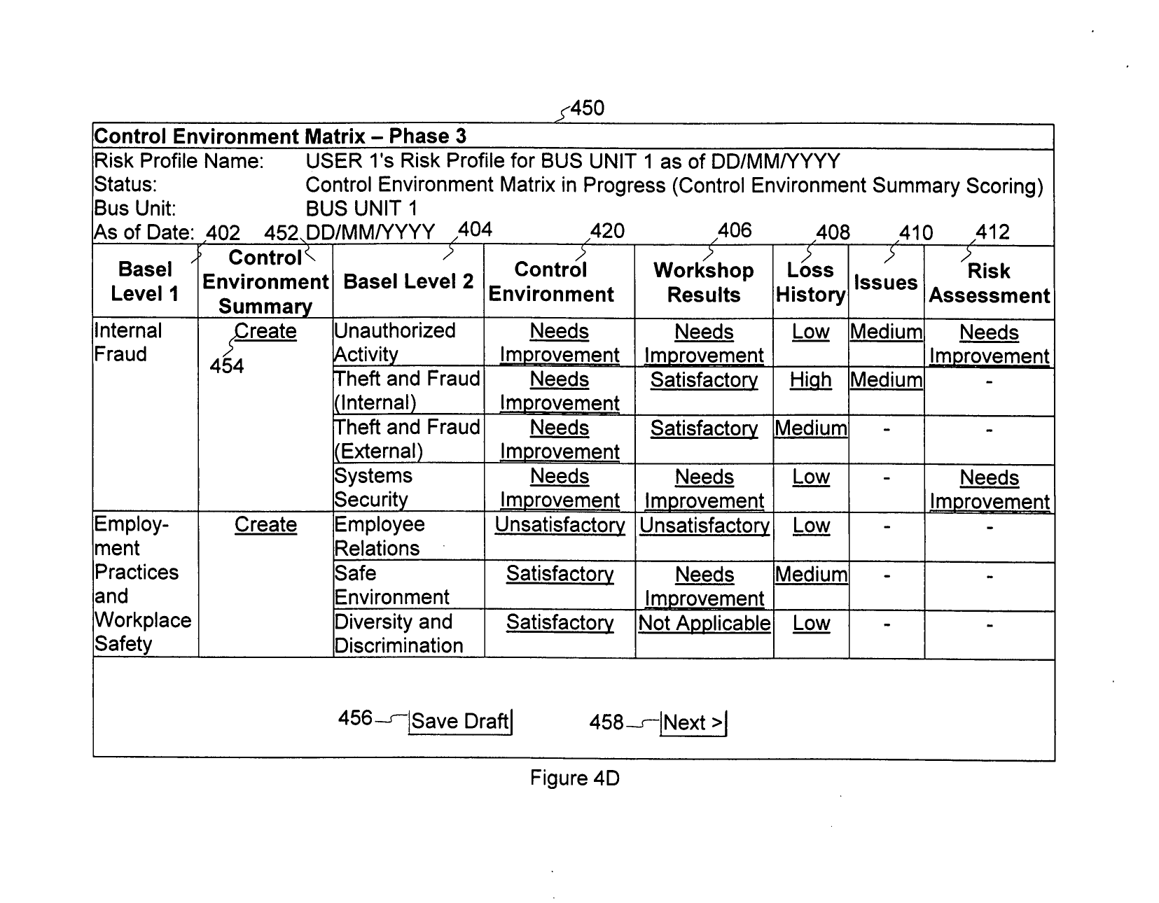

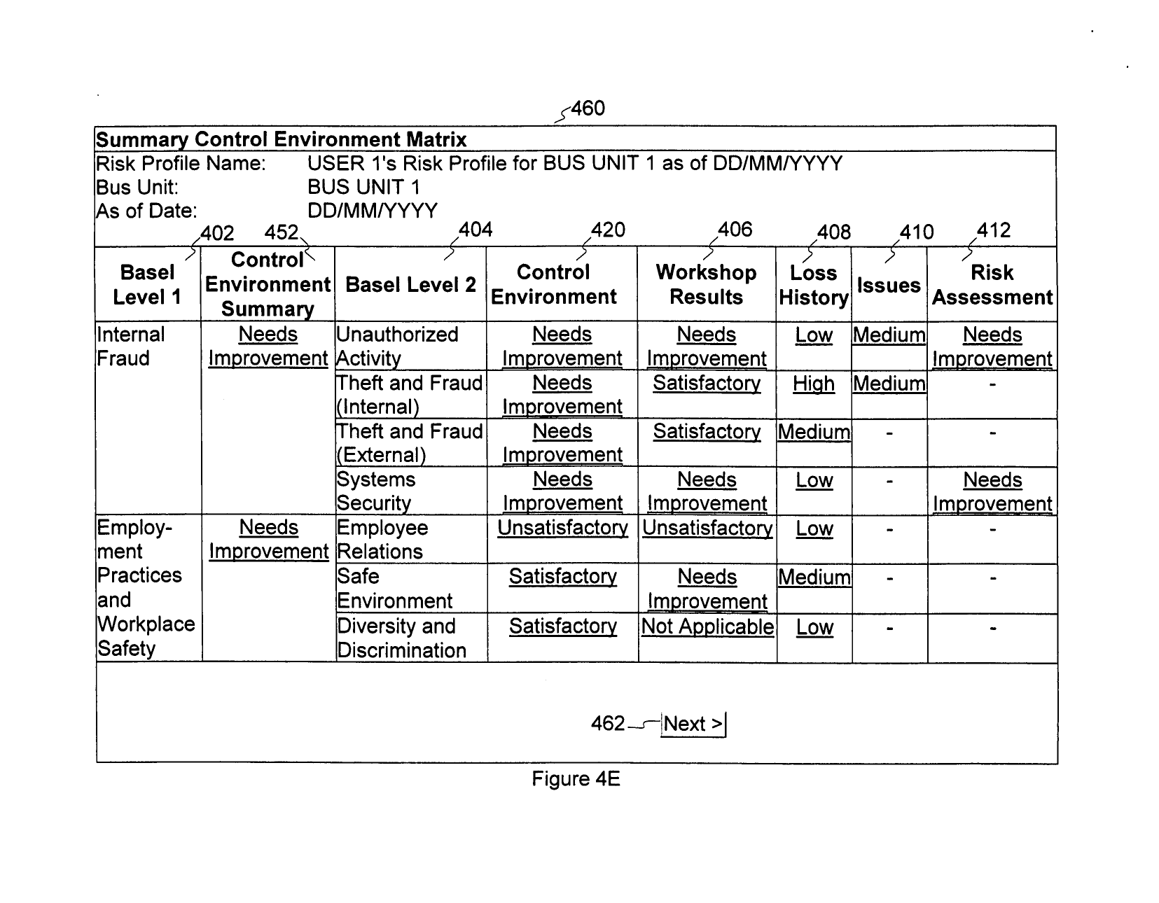

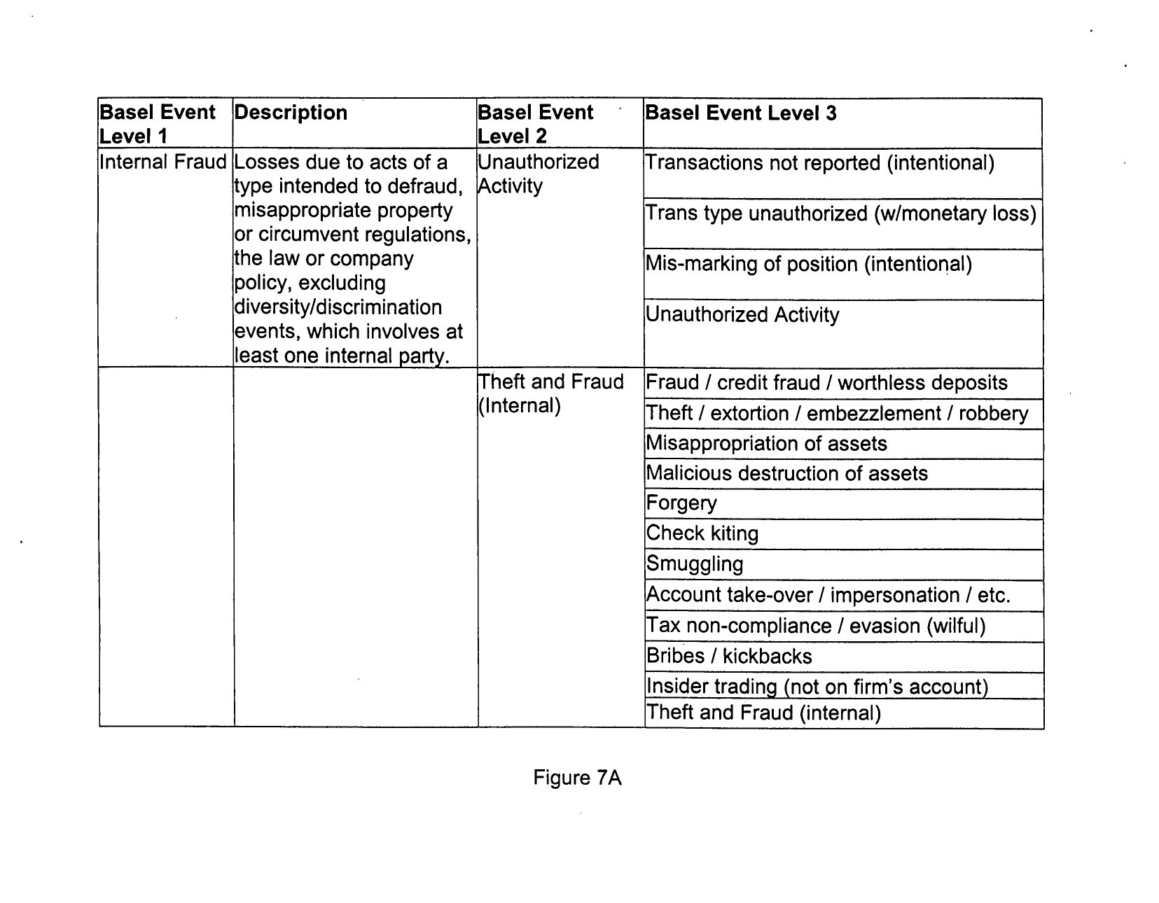

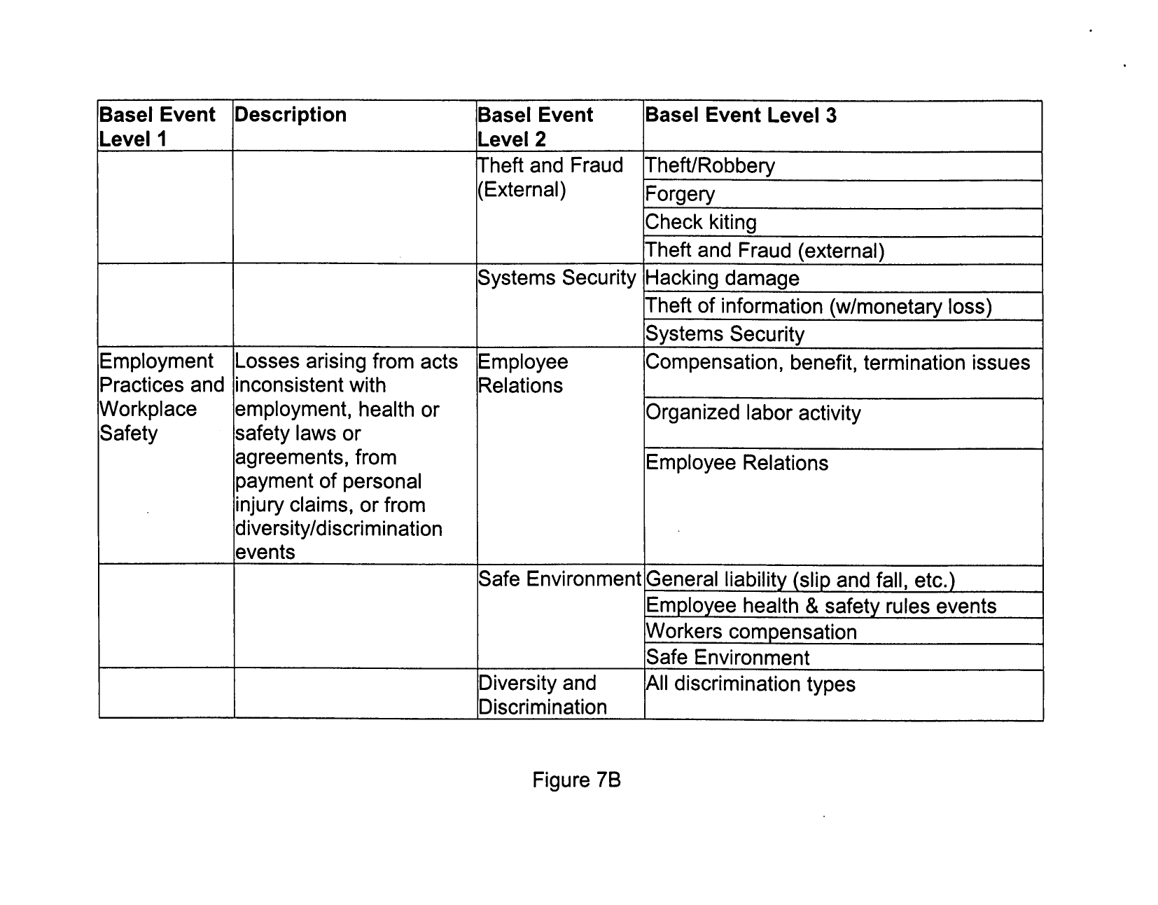

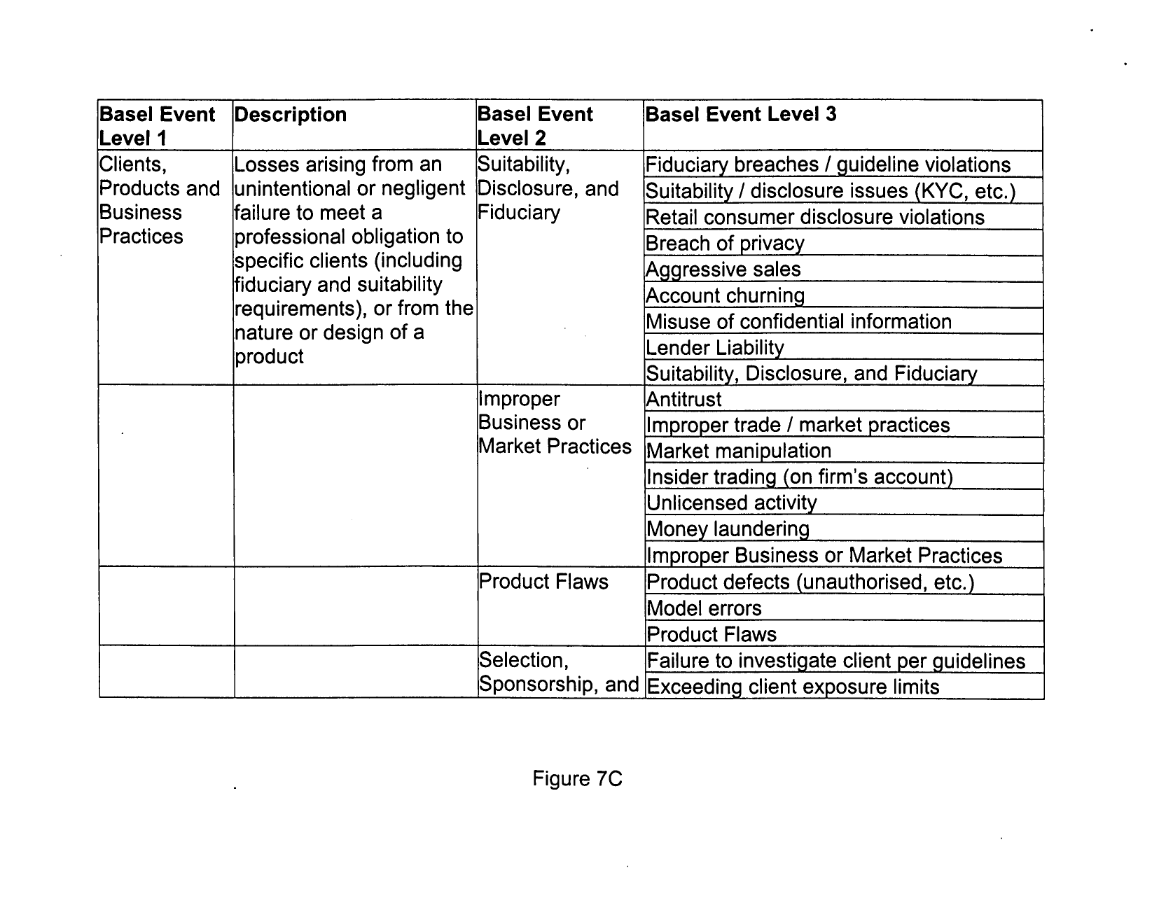

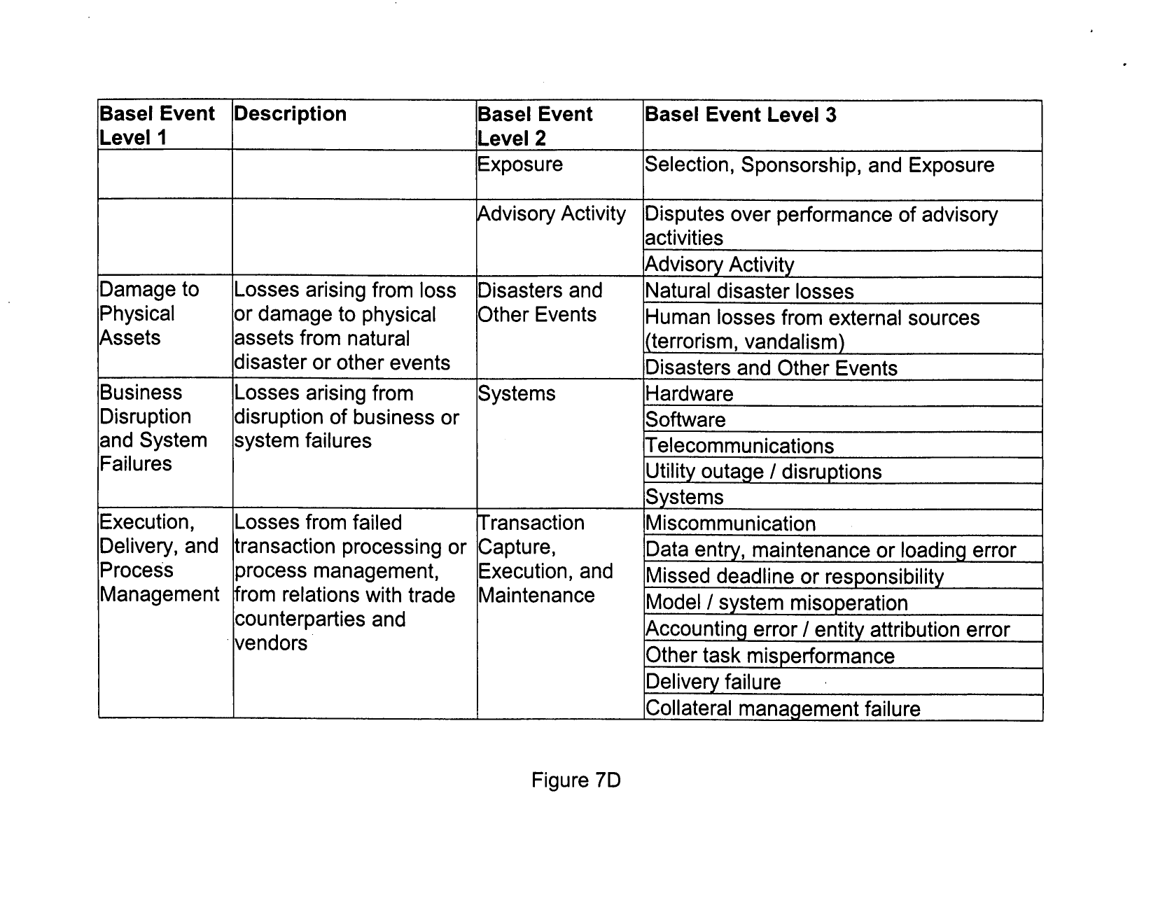

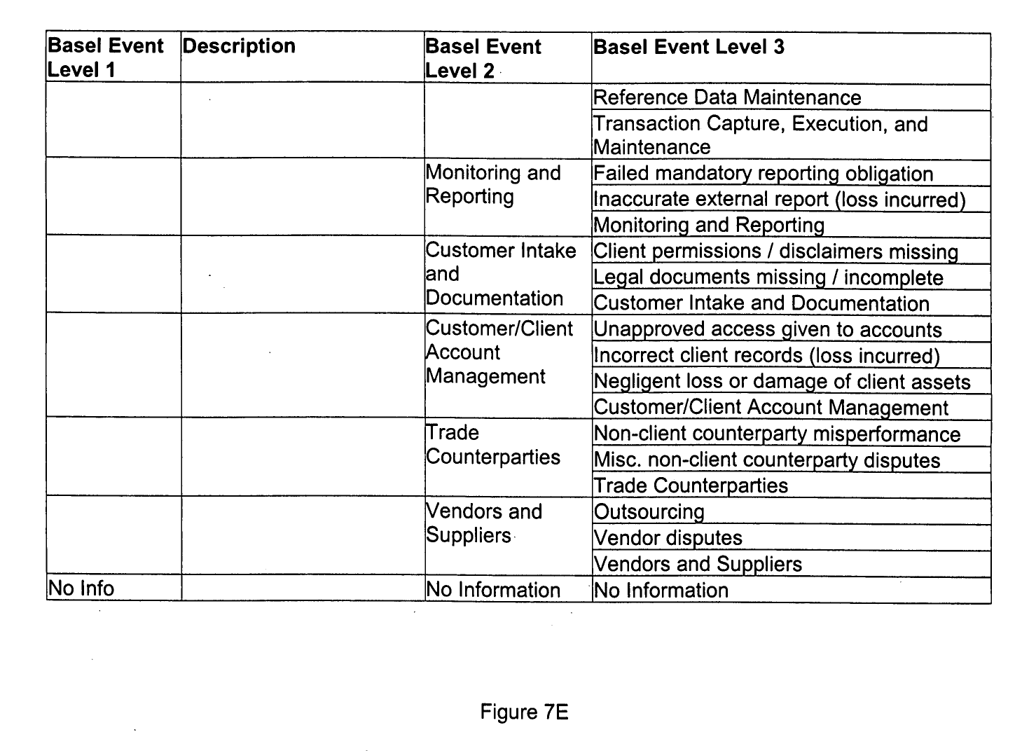

An exemplary user interface to a process for creating a Control Environment Matrix is illustrated in FIGS. 4A-E. Specifically, FIG. 4A illustrates an exemplary user interface 400 to a process for creating a phase one Control Environment Matrix. As can be seen from FIG. 4A, the columns of a phase one Control Environment Matrix 400 may include a Basel Level 1 loss event type column 402, a Basel Level 2 loss event type column 404, a Workshop Results column 406, a Loss History column 408, an Issues column 410 and a Risk Assessment column 412. Each row of a phase one Control Environment Matrix may include a Basel Level 2 loss event type and a corresponding rating for Loss History, Issues and Risk Assessment for each Basel Level 2 loss event type. For purposes of conciseness, not all of the Basel Level 2 loss event types are shown in FIG. 4A. A complete listing, however, of Basel Level 2 loss event types and the corresponding Basel Level 1 loss event types is set forth in FIGS. 7A-7E.

As mentioned above, a first phase of completing a Control Environment Matrix may be to assign a Workshop rating to each Basel Level 2 loss event type. A Loss History column 408, an Issues column 410 and a Risk Assessment column 412, however, may have been populated by executing the corresponding administrative processes, which were discussed above.

A Loss History rating for a given Basel Level 2 loss event type may be, for example, High, Medium, or Low. A Loss History rating may be determined, for example, on the basis of predetermined thresholds for each Basel Level 2 loss event type, for each business unit, for a predetermined period of time, e.g., the most recent twelve (12) months. For example, a High Loss History rating may be assigned to a Basel Level 2 loss event type if, for the prior twelve (12) months, the sum of operational losses is greater than or equal to $750,000 and the maximum operational loss is greater than or equal to $375,000, or if, for the prior twelve (12) months, the sum of operational losses greater than or equal to $750,000 and the average operational loss is greater than or equal to $250,000. A Medium Loss History rating may be assigned to a Basel Level 2 loss event type if, for the prior twelve (12) months, the sum of operational losses is greater than or equal to $20,000 and the maximum operational loss is greater than or equal to $15,000, or if, for the prior twelve (12) months, the sum of operational losses is greater or equal to $20,000 and the average operational loss is greater than or equal to $12,500. A Low Loss History rating may be assigned to a Basel Level 2 loss event type if, for the prior twelve (12) months, the sum of operational losses is less than $20,000 and the maximum operational loss is less than $15,000, or if, for the prior twelve (12) months, the sum of operational losses is less than $20,000 and the average operational loss is less than $12,500.

A process for displaying user interface 400 may be configured to display each cell in a Loss History column 408 with a predetermined color that corresponds to a Loss History rating for that particular Basel Level 2 loss event type. For example, if a Loss History rating for a particular cell is Low, the cell also may be displayed in the color green. Similarly, if a Loss History rating for a particular cell is Medium, the cell also may be displayed in the color yellow, and if a Loss History rating for a particular cell is High, the cell also may be displayed in the color red.

An Issues rating for a given Basel Level 2 loss event type may be, for example, High, Medium, or Low. An Issues rating for a given Basel Level 2 loss event type may be based on the most significant open issue within the As Of Date limits for that Basel Level 2 loss event type. A process for displaying user interface 400 may be configured to display each cell in an Issues 410 column with a predetermined color that corresponds to an Issues rating for that particular Basel Level 2 loss event type. For example, if an Issues rating for a particular cell is Low, the cell also may be displayed in the color green. Similarly, if an Issues rating for a particular cell is Medium, the cell also may be displayed in the color yellow, and if an Issues rating for a particular cell is High, the cell also may be displayed in the color red. The process may be configured so that a default Issues rating is High. A Basel Level 2 loss event type that has not been previously assigned an Issues rating would be assigned a default value.

A Risk Assessment rating for a given Basel Level 2 loss event type may be, for example, Satisfactory, Needs Improvement, or Unsatisfactory. Risk Assessment ratings may be based on an un-weighted average of all risk assessment survey scores with dates that are earlier than the As Of Date of the risk profile. A process for displaying user interface 400 may be configured to display each cell in a Risk Assessment column 412 with a predetermined color that corresponds to a Risk Assessment rating for that particular Basel Level 2 loss event type. For example, if a Risk Assessment rating for a particular cell is Satisfactory, the cell also may be displayed in the color green. Similarly, if a Risk Assessment rating for a particular cell is Needs Improvement, the cell also may be displayed in the color yellow, and if a Risk Assessment rating for a particular cell is Unsatisfactory, the cell also may be displayed in the color red.

Continuing with FIG. 4A, a Workshop Results rating may be assigned to one or more Basel Level 2 loss event types by selecting a Create link in the same row as the corresponding Basel Level 2 loss event type. For example, to assign a Workshop Results rating to Basel Level 2 loss event type Unauthorized Activity, Create Link 414 may be selected. Selecting Create link 414 will cause a user interface 420 to a Enter Workshop Results process to be displayed, as illustrated in FIG. 4B, whereby a user can assign a Workshop Results rating to a corresponding Basel Level 2 loss event type.

As can be seen from FIG. 4B, user interface 420 may be configured to display a Risk Profile Name and the relevant Basel Level 1 loss event type and Basel Level 2 loss event type. A Workshop Date field 422 may be provided for entry of the date of the workshop. A Rating radio button 424 may be provided whereby a user may assign a Workshop Results rating to the selected Basel Level 2 loss event type. Exemplary Workshop Results ratings may be High, Medium, and Low. Not Rated and Not Applicable ratings may also be provided. A Workshop Results rating may be based on the judgment of operational risk management personnel based on a Workshop Planning Report, which is discussed above. A Comment field 426 also may be provided wherein comments may be entered that relate to the assigned Workshop Results rating for the Basel Level 2 loss event type. A Create Issue Now radio button 428 may be provided which will launch a Create Issue Now process if selected. A Cancel button 430 may be provided to cancel the Enter Workshop Results process. A Submit button 432 may be provided to submit a Workshop Results rating for a selected Basel Level 2 loss event type. Selecting a Submit button 432 will cause a user interface 400, which is illustrated in FIG. 4A, to a process for creating a phase one Control Environment Matrix to be displayed again.

Returning to FIG. 4A, a Workshop Results rating may be assigned to one or more other Basel Level 2 loss event types in the manner described above. A Save Draft button 416 may be provided which, if selected, will cause information previously entered into a Control Environment Matrix to be saved. A Next button 418 also may be provided, which may be selected if Workshop Results ratings have been assigned to the Basel Level 2 loss event types. Selecting the Next button 418 will cause a user interface 440 to a process for creating a phase two Control Environment Matrix to be displayed, which is illustrated in FIG. 4C.

FIG. 4C illustrates an exemplary user interface 440 to a process for creating a phase two Control Environment Matrix. As can be seen from FIG. 4C, a phase two Control Environment Matrix may include the same columns as a phase one Control Environment Matrix, as well as a Control Environment column 420. A Control Environment rating may be entered for each Basel Level 2 loss event type by selecting a Create link in the same row as the corresponding Basel Level 2 loss event type. For example, to assign a Control Environment rating to a Basel Level 2 loss event type Unauthorized Activity, Create link 422 may be selected. Selecting Create link 422 will cause a user interface (not shown) to an Assign Control Environment Rating process, whereby a user may assign a Control Environment rating to the corresponding Basel Level 2 loss event type. The user interface may be configured to display a Risk Profile Name and the relevant Basel Level 1 loss event type and Basel Level 2 loss event type. A Rating radio button may be provided whereby a user may assign a Control Environment rating to the selected Basel Level 2 loss event type. Exemplary ratings may be Unsatisfactory, Needs Improvement, Satisfactory. A Not Applicable rating may also be provided. A Control Environment rating may be thought of as a summary rating for the control environment for the selected Basel Level 2 loss event type for the business unit. The rating may be manually assigned based on the judgment of operational risk management personnel considering the ratings for Loss History, Risk Assessment, Issues, and Workshop Results. The following Control Environment rating definitions may be used: Unsatisfactory—the current control environment may be unacceptable because sufficient controls do not exist to ensure a risk is adequately managed; corrective actions and improvements may need to be implemented; Needs Improvement—controls may display modest weakness or deficiencies, but are correctable in the normal course of business; and Satisfactory—the current control environment is meeting the minimum standards needed to adequately manage the risk; no improvements are currently necessary. A Comment field also may be provided wherein comments may be entered that relate to the selected rating for the Basel Level 2 loss event type. A Cancel button may be provided to cancel the Assign Control Environment Rating process. A Submit button may be provided to submit a Control Environment rating for a selected Basel Level 2 loss event type. Selecting a Submit button will cause a user interface 440, which is illustrated in FIG. 4C, to a process for creating a phase two Control Environment Matrix process to be displayed again.

Returning to FIG. 4C, Control Environment rating may be assigned to one or more other Basel Level 2 loss event types in the manner described above. A Save Draft button 424 may be provided which, if selected, will cause information previously entered into a Control Environment Matrix to be saved. A Next button 426 also may be provided, which may be selected if Control Environment ratings have been assigned to the Basel Level 2 loss event types. Selecting the Next button 426 will cause a user interface 450 to a process for creating a phase three Control Environment Matrix to be displayed, which is illustrated in FIG. 4D.

FIG. 4D illustrates an exemplary user interface 450 to a process for creating a phase three Control Environment Matrix. As can be seen from FIG. 4D, a phase three Control Environment Matrix may include the same columns as a phase two Control Environment Matrix, as well as a Control Environment Summary column 452. A Control Environment Summary rating may be assigned to each Basel Level 1 loss event type by selecting a Create link in the same row as the corresponding Basel Level 1 loss event type. For example, to assign a Control Environment Summary rating to a Basel Level loss event type Internal Fraud, Create link 454 may be selected. Selecting Create link 454 will cause a user interface (not shown) to an Assign Control Environment Summary Rating process, whereby a user may assign a Control Environment Summary rating to the corresponding Basel Level 1 loss event type. The user interface may be configured to display a Risk Profile Name and the relevant Basel Level 1 loss event type. A Rating radio button may be provided whereby a user may assign a Control Environment Summary rating to the selected Basel Level 1 loss event type. The rating scale may be the same as used for assigning Control Environment ratings to the Basel Level 2 loss event types. A Control Environment Summary rating may be manually assigned based on the judgment of operational risk management personnel considering the Control Environment ratings for the Basel Level 2 loss event types. A Comment field also may be provided wherein comments may be entered that relate to the selected rating for the Basel Level 1 loss event type. A Cancel button may be provided to cancel the Assign Control Environment Summary Rating process. A Submit button may be provided to submit a Control Environment Summary rating for a selected Basel Level 1 loss event type. Selecting a Submit button will cause a user interface 450, which is illustrated in FIG. 4D, to a process for creating a phase three Control Environment Matrix process to be displayed again.

Returning to FIG. 4D, Control Environment Summary rating may be assigned to one or more other Basel Level 1 loss event types in the manner described above. A Save Draft button 456 may be provided which, if selected, will cause information previously entered into a phase three Control Environment Matrix to be saved. A Next button 458 also may be provided, which may be selected if Control Environment Summary ratings have been assigned to the Basel Level 1 loss event types. Selecting the Next button 456 will cause a Summary Control Environment Matrix 460 to be displayed, which is illustrated in FIG. 4E.

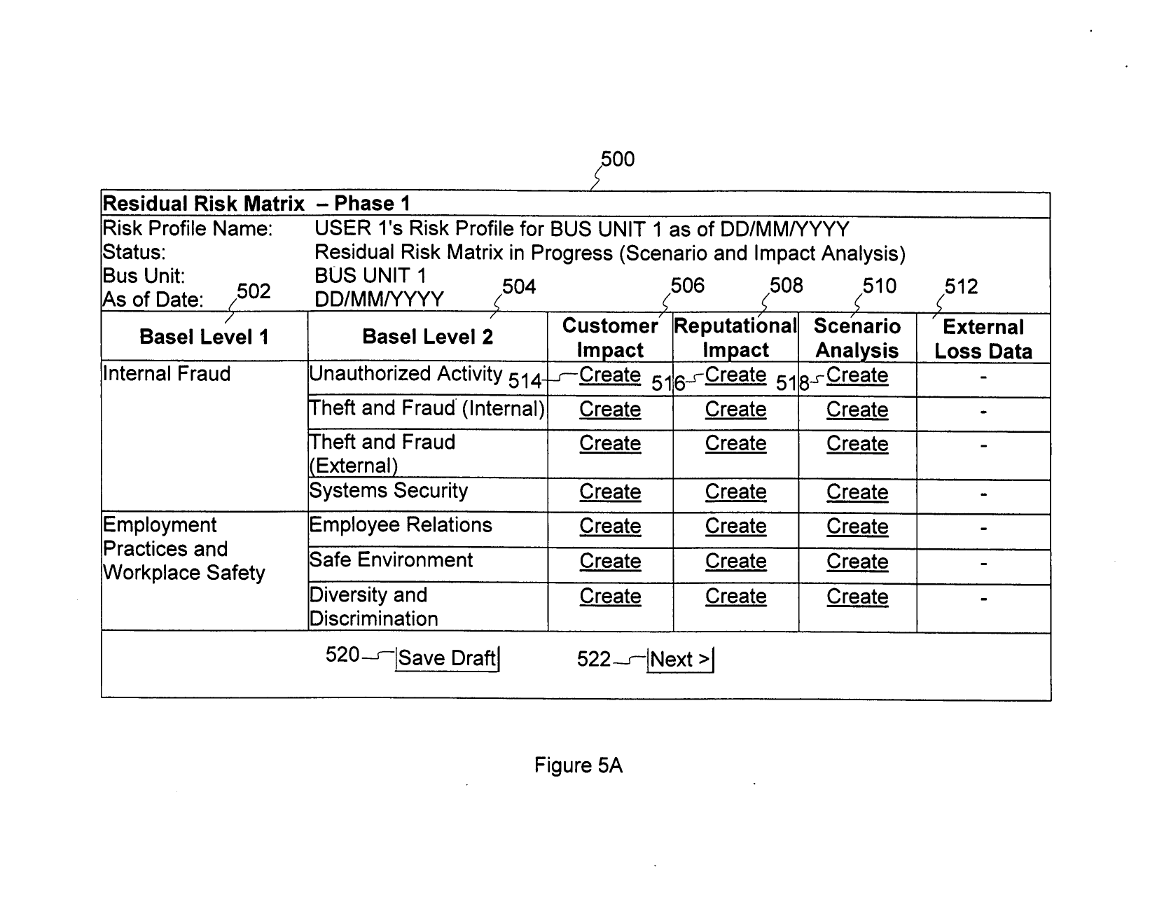

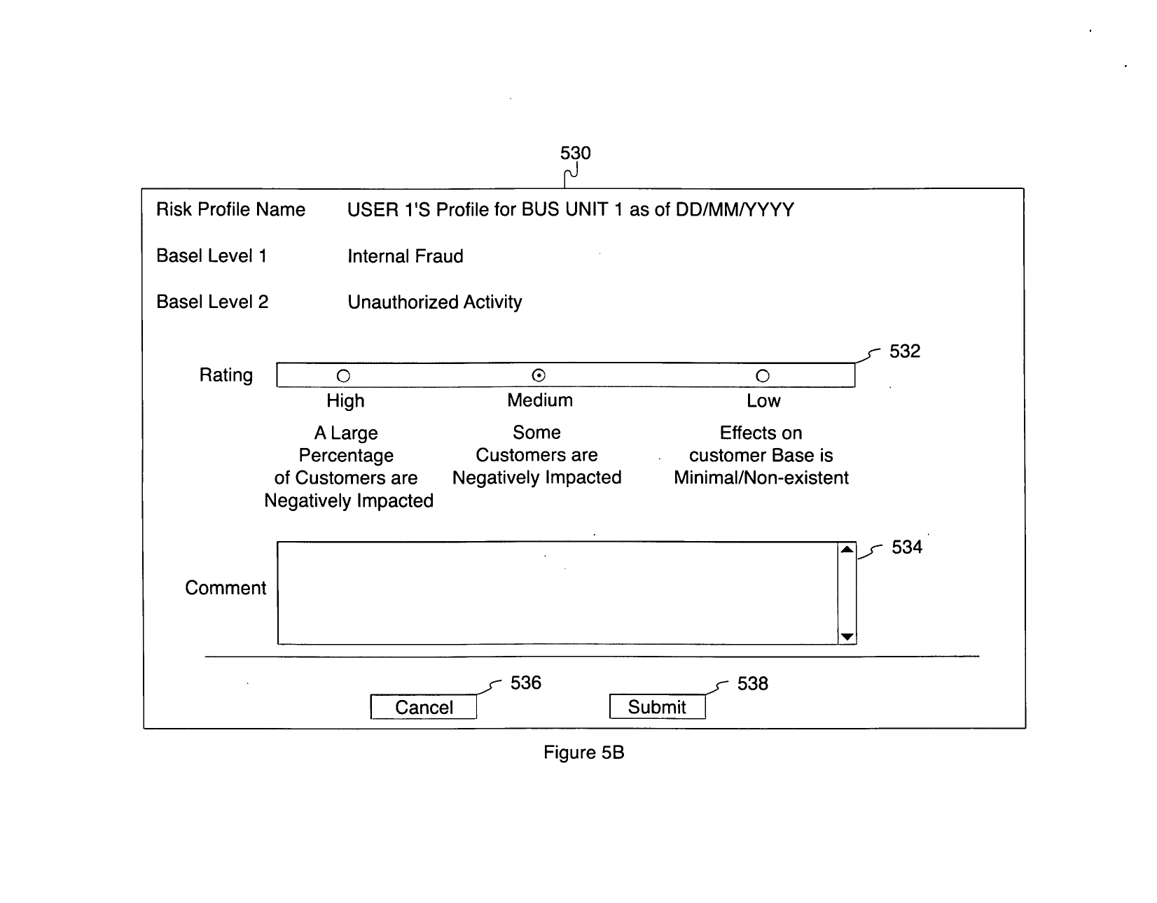

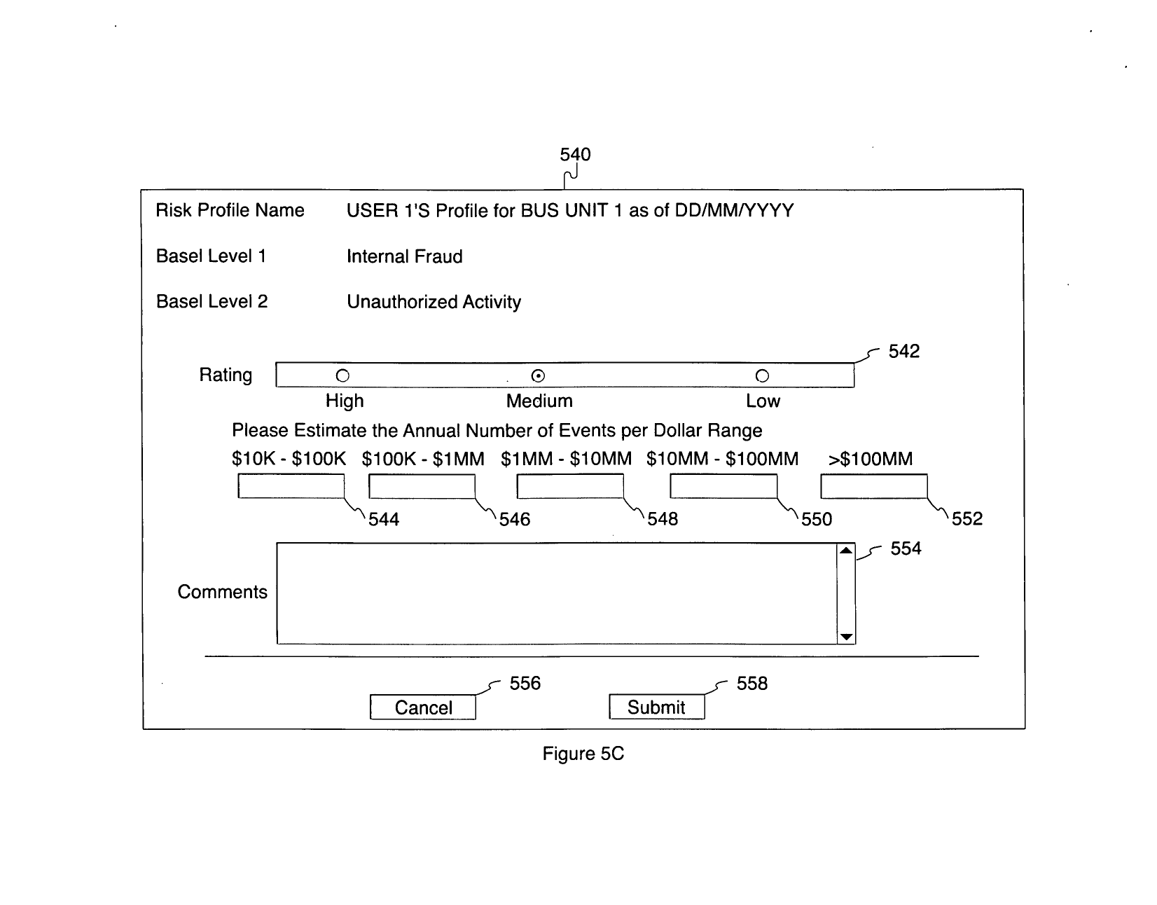

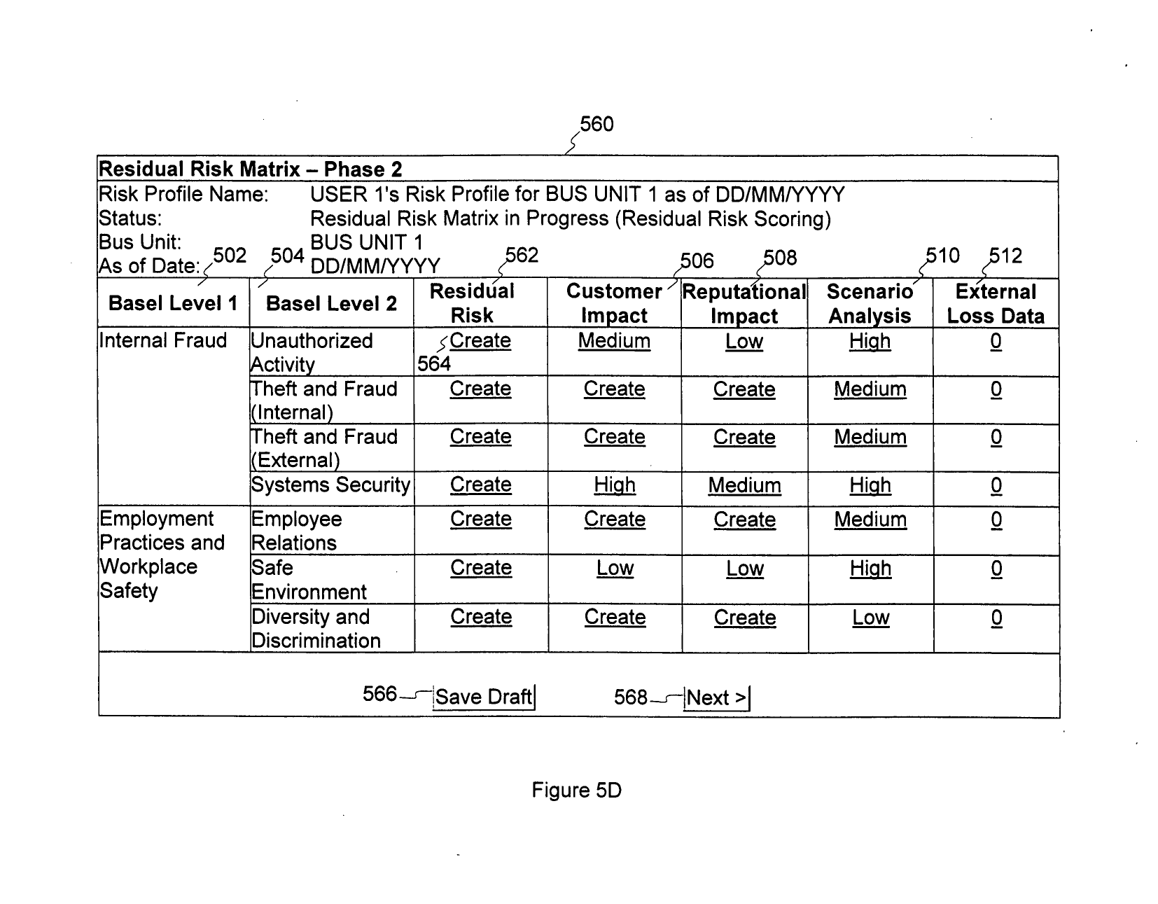

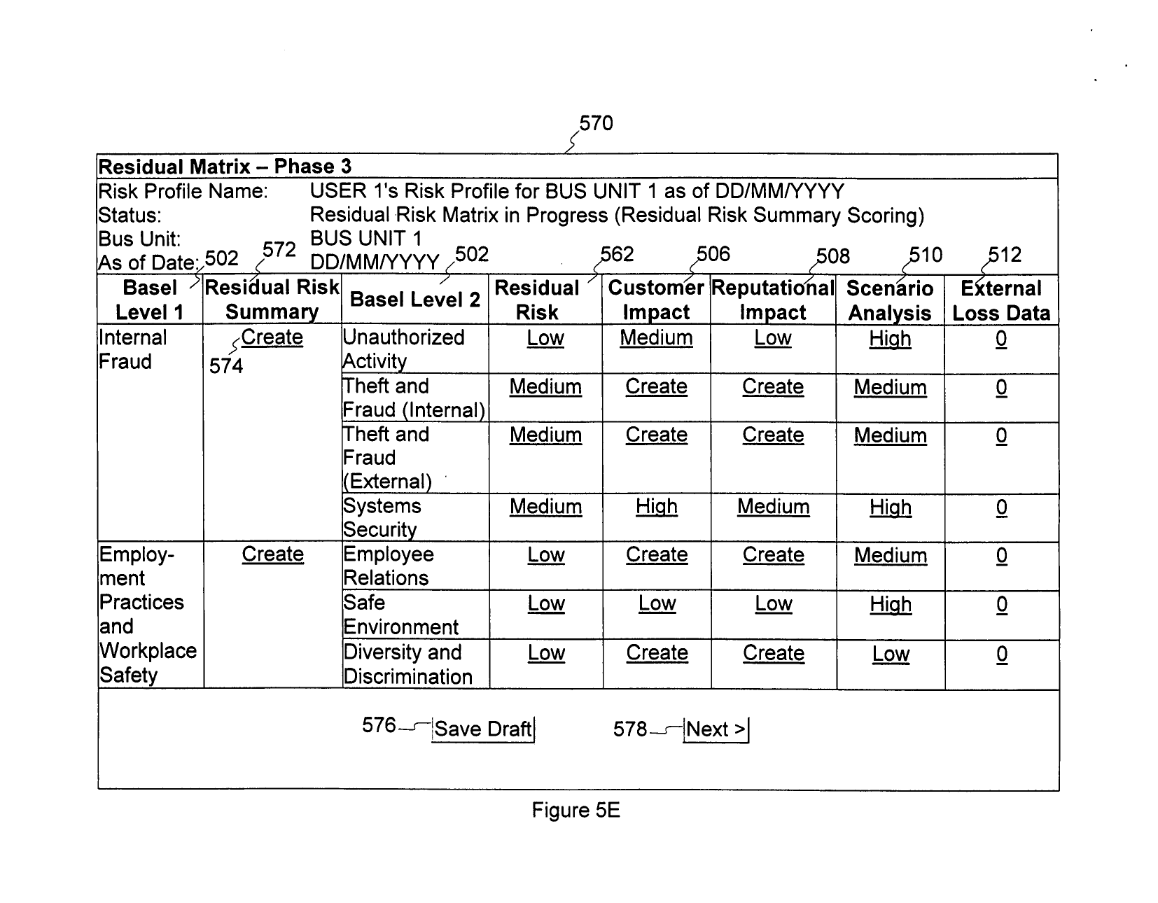

As can be seen from FIG. 4E, a Summary Control Environment Matrix 460 may include Control Environment Summary column 452 for displaying Control Environment Summary ratings assigned to one or more Basel Level 1 loss event types set forth in a Basel Level 1 column 402. The Summary Control Environment Matrix 460 may also include a Control Environment column 420 for displaying Control Environment ratings assigned to one or more Basel Level 2 loss event types set forth in a Basel Level 2 column 404. The Summary Control Environment Matrix 460 may also include a Workshop Results column 406, a Loss History column 408 and Issue column 410 and a Risk Assessment column 412 for displaying Workshop Results ratings, Loss History ratings, Issues ratings and Risk Assessment ratings, respectively, assigned to one or more Basel Level 2 loss event types set forth in a Basel Level 2 column 404. A Next button 462 also may be provided, which may be selected after reviewing the Summary Control Environment Matrix 460. Selecting the Next button 462 will complete the process of determining a Control Environment rating and will cause a user interface 500 to a process for creating a first phase Residual Risk Matrix to be displayed, which is illustrated in FIG. 5A.

Determining a Residual Risk Rating

To facilitate the determination of a residual risk rating for one or more loss event types, a process for creating a Residual Risk Matrix may be provided. A Residual Risk Matrix may be completed in three phases. A first phase may include assigning a Scenario Analysis rating, Customer Impact rating and Reputational Impact rating for one or more loss event types. A second phase may include determining a residual risk rating for one or more lower level loss event types, such as Basel Level 2 loss event types. A third phase may include determining a residual risk rating for one or more upper level loss event types, such as Basel Level 1 loss event types. Each of these phases will be discussed in more detail below.

An exemplary user interface to a process for creating the phases of a Residual Risk Matrix is illustrated in FIGS. 5A-F. Specifically, FIG. 5A illustrates an exemplary user interface 500 to a process for creating a phase one Residual Risk Matrix. As can be seen from FIG. 5A, the columns of a phase one Residual Risk Matrix 500 may include a Basel Level 1 loss event type column 502, a Basel Level 2 loss event type column 504, a Customer Impact column 506, a Reputational Impact column 508, a Scenario Analysis column 510, an External Loss Data column 512. A user interface to creating a phase one Residual Risk Matrix also may include a Control Environment column (not shown), which may be populated with the corresponding Control Environment rating that was previously assigned to the particular loss event type. Each row of a phase one Residual Risk Matrix may include a Basel Level 2 loss event type and a corresponding rating for customer impact, Reputational impact, Scenario Analysis, External Loss Data and Control Environment for each Basel Level 2 loss event type. For purposes of conciseness, not all of the Basel Level 2 loss event types are shown in FIG. 4A. A complete listing, however, of Basel Level 2 loss event types and the corresponding Basel Level 1 loss event types is set forth in FIGS. 7A-7E.

As mentioned above, a first phase of completing a Residual Risk Matrix may include assigning a Scenario Analysis rating, Customer Impact rating and Reputational Impact rating for one or more loss event types, such as a Basel Level 2 loss event type.

Continuing with FIG. 5A, a Customer Impact rating may be assigned to one or more Basel Level 2 loss event type by selecting a Create link in the same row as the corresponding Basel Level 2 loss event type. For example, to assign a Customer Impact rating to Basel Level 2 loss event type Unauthorized Activity, Create Link 514 may be selected. Selecting Create link 514 may cause a user interface 530 to an Assign Customer Impact rating process to be displayed, as illustrated in FIG. 5B, whereby a user can assign a Customer Impact rating to a corresponding Basel Level 2 loss event type. Assigning Customer Impact ratings may be optional; Customer Impact ratings may be assigned, however, if a business unit's operational loss for a particular loss event type may have an impact on an enterprise's customers.

As can be seen from FIG. 5B, user interface 530 may be configured to display a Risk Profile Name and the relevant Basel Level 1 loss event type and Basel Level 2 loss event type. A Rating radio button 532 may be provided whereby a user may assign a Customer Impact rating to the selected Basel Level 2 loss event type. Exemplary Customer Impact ratings may include: High, if a large percentage of customers may be negatively impacted; Medium, if some customers may be negatively impacted; and Low, if an effect on customers is minimal or non-existent. A Customer Impact rating may be based on an impact the loss event type may have on enterprise's customers based on the current control environment A Customer Impact rating may be based on the judgment of operational risk management personnel based on a Workshop Planning Report, which is discussed above. A Comment field 534 also may be provided wherein comments may be entered that relate to the assigned Customer Impact rating for the Basel Level 2 loss event type. A Cancel button 536 may be provided to cancel the Assign Customer Impact rating process. A Submit button 538 may be provided to submit a Customer Impact rating for a selected Basel Level 2 loss event type. Selecting a Submit button 538 will cause a user interface 500, which is illustrated in FIG. 5A, to a process for creating a phase one Residual Risk Matrix process to be displayed again.

Returning to FIG. 5A, a Reputational Impact rating may be assigned to one or more Basel Level 2 loss event type by selecting a Create link in the same row as the corresponding Basel Level 2 loss event type. For example, to assign a Reputational Impact rating to Basel Level 2 loss event type Unauthorized Activity, Create Link 516 may be selected. Selecting Create link 516 may cause a user interface (not shown) to an Assign Reputational Impact rating process to be displayed, whereby a user can assign a Reputational Impact rating to a corresponding Basel Level 2 loss event type. Assigning Reputational Impact ratings may be optional; Reputational Impact ratings may be assigned, however, if a business unit's operational loss for a particular loss event type may have an impact on an enterprise's reputation.

The user interface to an Assign Reputational Impact rating process may be configured to display a Risk Profile Name and the relevant Basel Level 1 loss event type and Basel Level 2 loss event type. A Rating radio button may be provided whereby a user may assign a Reputational Impact rating to a selected Basel Level 2 loss event type. Exemplary Reputational Impact ratings may include: High, if the reputational impact may be national news; Medium, if the reputational impact may be local or regional news; and Low, if the reputational impact may be internal news only. A Reputational Impact rating may be based on an impact the loss event type may have on enterprise's customers based on the current control environment A Reputational Impact rating may be based on the judgment of operational risk management personnel based on a Workshop Planning Report, which is discussed above. A Comment field also may be provided wherein comments may be entered that relate to the assigned Reputational Impact rating for the Basel Level 2 loss event type. A Cancel button may be provided to cancel the Assign Reputational Impact rating process. A Submit button may be provided to submit a Reputational Impact rating for a selected Basel Level 2 loss event type. Selecting a Submit button will cause a user interface 500, which is illustrated in FIG. 5A, to a process for creating a phase one Residual Risk Matrix process to be displayed again.

Returning to FIG. 5A, a Scenario Analysis rating may be assigned to one or more Basel Level 2 loss event type by selecting a Create link in the same row as the corresponding Basel Level 2 loss event type. For example, to assign a Scenario Analysis rating to Basel Level 2 loss event type Unauthorized Activity, Create Link 518 may be selected. Selecting Create link 518 may cause a user interface 540 to an Scenario Analysis process to be displayed, as illustrated in FIG. 5C, whereby a user can assign a Scenario Analysis rating to a corresponding Basel Level 2 loss event type. A Scenario Analysis rating may required for completing the risk profile (i.e., each cell may be required be completed), although every Basel Level 2 loss event type may not be required to have a Scenario Analysis rating.

As can be seen from FIG. 5C, user interface 540 may be configured to display a Risk Profile Name and the relevant Basel Level 1 loss event type and Basel Level 2 loss event type. A Rating radio button 542 may be provided, whereby a Scenario Analysis process automatically determines a Scenario Analysis rating of High, Medium or Law based on a number of estimated loss events entered in fields 544-552 and based on predetermined loss thresholds for the Basel Level 2 loss event types. A Comment field 554 also may be provided wherein comments may be entered that relate to the assigned Scenario Analysis rating for the Basel Level 2 loss event type. Such comments may include information upon which the estimates are based. A Cancel button 556 may be provided to cancel the Scenario Analysis process. A Submit button 558 may be provided to submit a Scenario Analysis rating for a selected Basel Level 2 loss event type. Selecting a Submit button 538 will cause a user interface 500, which is illustrated in FIG. 5A, to a process for creating a phase one Residual Risk Matrix process to be displayed again.

Scenario analysis may be thought of as a process of assessing possible future loss events and impacts based on the judgment and experience of business unit and/or operational risk management personnel. An exemplary definition of scenario analysis may be a process of assessing the likelihood (frequency) and impact (severity or magnitude) of expected (and unexpected) operational losses over a predetermined period of time in the future, e.g., the next twelve (12) months. Scenario analysis may include an assessment of budgeted losses. Scenario analysis may be conducted because operational losses for one or more loss event types (e.g., external fraud) may be reasonably estimated due to a high frequency of incurring an actual loss occurrence. There may be loss event types (e.g., system failures, damage to physical assets, etc.), however, for which estimating future losses may be difficult because of the relative infrequency of such losses. Thus, it may be desirable to provide a process to estimate such low-frequency, high impact loss events that may not be captured in historical loss data. Such estimates may be useful to operational risk management personnel for decision-making purposes as well as to for operational risk capital allocation purposes. Scenario analysis may not include, for example, every possible loss scenario that may occur, especially worst-case loss scenarios and/or low frequency (e.g., losses occurring less than once every 10 years) loss scenarios.

A process for estimating loss scenarios may be based on the knowledge and experience of business unit and/or operational risk management personnel with respect to operational losses experience by a business unit. A loss scenario analysis may consider historical losses, a business unit's internal control environment, changes in a business environment, and external loss data, e.g., industry loss experience. Thus, a Residual Risk rating may include an estimate of reasonably foreseeable loss events for various loss event types, such as Basel Level 2 loss event types, for a predetermined period of time in the future, e.g., a twelve (12) month period. For estimated loss events that may occur less than once per twelve (12) months, a fraction of a loss event may be estimated. For example, if a hurricane that would cause severe damage (e.g., $3 million) once every 10 years, one-tenth ( 1/10) of a loss event may be entered into a $1 million-$10 million range.

Returning to FIG. 5A, a Customer Impact rating, a Reputational Impact rating and/or a Scenario Analysis rating may be assigned to one or more other Basel Level 2 loss event types in the manner described above. An External Loss Data rating also may be assigned to one or more Basel Level 2 loss event types in the manner discussed above. A Save Draft button 520 may be provided which, if selected, will cause information previously entered into the Residual Risk Matrix to be saved. A Next button 522 also may be provided, which may be selected if the desired Customer Impact ratings, Reputational Impact ratings, Scenario Analysis ratings and/or External Loss Data ratings have been assigned to the Basel Level 2 loss event types. Selecting the Next button 522 will cause a user interface 560 to a process for creating a phase two Residual Risk Matrix to be displayed, which is illustrated in FIG. 5D.

FIG. 5D illustrates an exemplary user interface 560 to a process for creating phase two Residual Risk Matrix. As can be seen from FIG. 5D, a phase two Residual Risk Matrix may include the same columns as a phase one Residual Risk Matrix, as well as a Residual Risk column 562. A Residual Risk rating may be assigned to each Basel Level 2 loss event type by selecting a Create link in the same row as the corresponding Basel Level 2 loss event type. For example, to assign a residual risk rating to Basel Level 2 loss event type Unauthorized Activity, Create link 564 may be selected. Selecting Create link 564 will cause a user interface (not shown) to an Assign Residual Risk Rating process, whereby a user may assign a residual rating to the corresponding Basel Level 2 loss event type. The user interface may be configured to display a Risk Profile Name and the relevant Basel Level 1 loss event type and Basel Level 2 loss event type. A Rating radio button may be provided whereby a user may assign a residual risk rating to the selected Basel Level 2 loss event type. Exemplary ratings may be Unsatisfactory, Needs Improvement, Satisfactory. A Not Applicable rating may also be provided. A residual rating may be thought of as a summary rating for the control environment for the selected Basel Level 2 loss event type for the business unit. The rating may be manually assigned based on the judgment of operational risk management personnel and considering the ratings for customer impact, reputational impact and scenario analysis. External Loss Data ratings, which may be displayed in a phase two Residual Risk Matrix (see FIG. 5D) and which may provide information about losses incurred by other enterprise's within an industry, may also be considered in assigning a residual risk rating. Control Environment ratings, which also may be displayed in a phase 3 Residual Risk Matrix and which provide information about a business unit's current internal capabilities for operational risk management, may also be considered in assigning a residual risk rating. The following rating definitions may be used: Unsatisfactory—the residual risk may be unacceptable because sufficient controls do not exist to ensure a risk is adequately managed; corrective actions and improvements may need to be implemented; Needs Improvement—controls may display modest weakness or deficiencies, but are correctable in the normal course of business; and Satisfactory—the current control environment is meeting the minimum standards needed to adequately manage the risk; no improvements are currently necessary. A Comment field also may be provided wherein comments may be entered that relate to the selected residual risk rating for the Basel Level 2 loss event type. A Cancel button may be provided to cancel the Assign Residual Risk Rating process. A Submit button may be provided to submit a residual risk rating for a selected Basel Level 2 loss event type. Selecting a Submit button will cause a user interface 560, which is illustrated in FIG. 5D, to a process for creating a Residual Risk Matrix to be displayed again.

Returning to FIG. 5D, residual risk rating may be assigned to one or more other Basel Level 2 loss event types in the manner described above. A Save Draft button 566 may be provided which, if selected, will cause information previously entered into a Residual Risk Matrix to be saved. A Next button 568 also may be provided, which may be selected if residual risk ratings have been assigned to the Basel Level 2 loss event types. Selecting the Next button 426 will cause a user interface 570 to a process for creating a phase three Residual Risk Matrix to be displayed, which is illustrated in FIG. 5E.

FIG. 5E illustrates an exemplary user interface 570 to a process for creating a phase three Residual Risk Matrix. As can be seen from FIG. 5E, a phase three Residual Risk Matrix may include the same columns as a phase two Residual Risk Matrix, as well as a Residual Risk Summary column 572. A residual risk summary rating may be assigned to each Basel Level 1 loss event type by selecting a Create link in the same row as the corresponding Basel Level 1 loss event type. For example, to assign a residual risk summary rating to a Basel Level 1 loss event type Internal Fraud, Create link 574 may be selected. Selecting Create link 574 may cause a user interface (not shown) to an Assign Residual Risk Summary Rating process, whereby a user may assign a residual risk summary rating to the corresponding Basel Level 1 loss event type. The user interface may be configured to display a Risk Profile Name and the relevant Basel Level 1 loss event type. A Rating radio button may be provided whereby a user may assign a residual risk summary rating to the selected Basel Level 1 loss event type. The rating scale may be the same as used for assigning residual risk ratings to the Basel Level 2 loss event types. The rating may be manually assigned based on the judgment of operational risk management personnel considering the residual risk ratings for the Basel Level 2 loss event types. A Comment field also may be provided wherein comments may be entered that relate to the selected rating for the Basel Level 1 loss event type. A Cancel button may be provided to cancel the Assign Residual Risk Summary Rating process. A Submit button may be provided to submit a residual risk summary rating for a selected Basel Level 1 loss event type. Selecting a Submit button will cause a user interface 570, which is illustrated in FIG. 5E, to a process for creating a phase three Residual Risk Matrix to be displayed again.

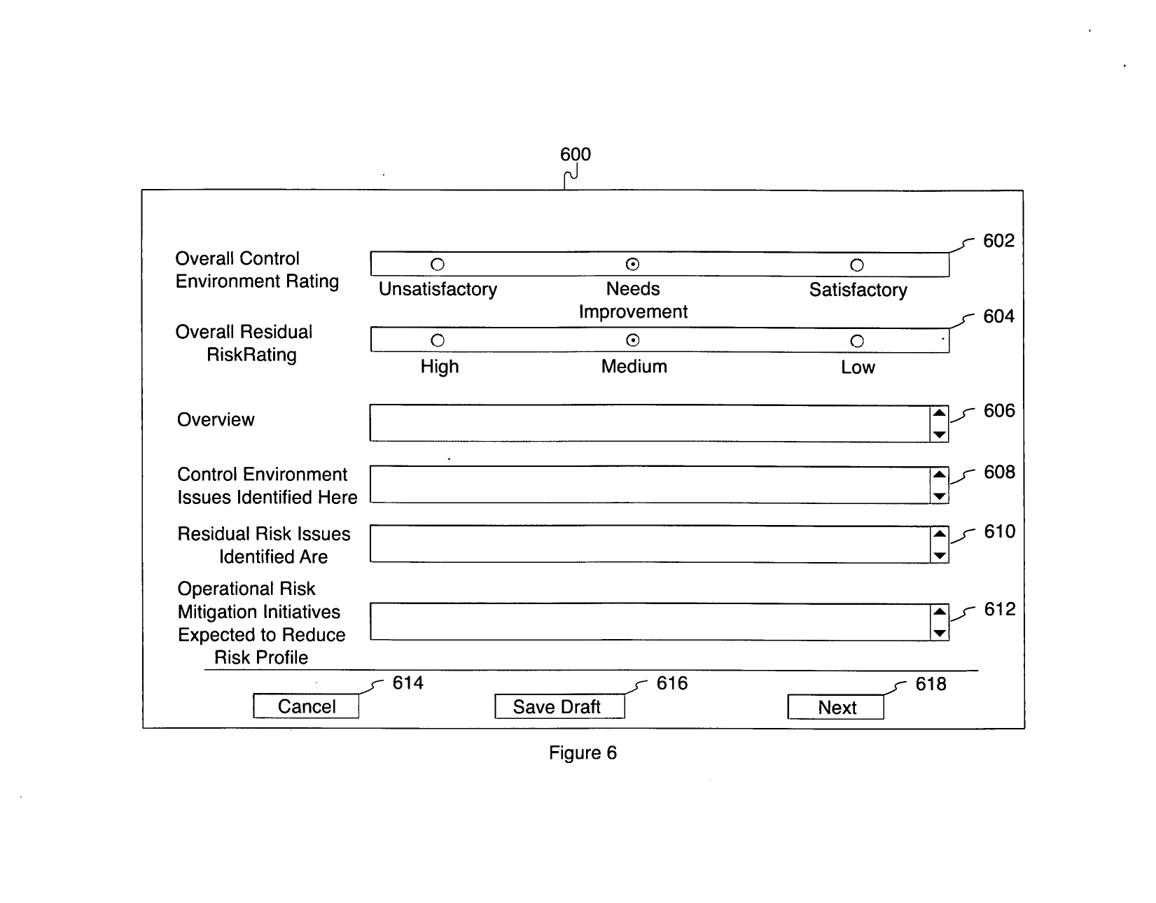

Returning to FIG. 5E, residual risk summary rating may be assigned to one or more other Basel Level 1 loss event types in the manner described above. A Save Draft button 576 may be provided which, if selected, will cause information previously entered into a phase three Residual Risk Matrix to be saved. A Next button 578 also may be provided, which may be selected if residual risk summary ratings have been assigned to the Basel Level 1 loss event types. Selecting the Next button 576 will cause a user interface 600 to a Create Executive Summary process to be displayed, which is illustrated in FIG. 6.

Creating an Executive Summary

Referring to FIG. 6, an exemplary user interface 600 to a process for creating an executive summary of a business unit's risk profile is illustrated. A Create Executive Summary process may include determining an overall Control Environment rating. A radio button 602 may be provided to facilitate the process of determining an overall Control Environment rating. An overall Control Environment rating may be Unsatisfactory, Needs Improvement or Satisfactory. A Create Executive Summary process may include determining an overall residual risk rating. A radio button 602 may be provided to facilitate the process of determining an overall residual risk rating. A residual risk rating may be Unsatisfactory, Needs Improvement or Satisfactory. User interface 600 may provide an overview area 606 for providing information relating to a rationale of the overall Control Environment rating and/or overall residual risk rating. User interface 600 may also provide a area 608 for identifying control environment issues. Specific risk control weaknesses that should addressed may be identified in area 608. User interface 600 may also provide an area 610 for identifying residual risk issues. Specific risk impacts that should addressed may be identified in area 610. User interface 600 may also provide an area 612 for identifying operational risk mitigation initiatives expected to reduce risk. A Cancel button 614 may be provided to cancel the Create Executive Summary process. A Save Draft button 616 may be provided to save information entered via the Create Executive Summary process. A Next button 618 may be provided, which, if selected, may cause a confirmation (not shown) to be displayed confirms that an executive summary has been created.

The Create Risk Profile process also may be configured to display a user interface (not shown) to a Request To Review Risk Profile For Approval process, which may be launched upon completion of a Create Executive Summary process. The user interface may provide for a designation of operational risk management personnel to whom a completed risk profile should be sent for review and approval. In addition, the user interface also may provide for a designation of business unit management personnel to whom a completed risk profile should be sent for review and approval. The user interface also may provide for an area to include comments and/or instructions to designated business unit and/or operational risk management personnel to whom a risk profile is submitted for review and approval. Upon approval of the risk profile by designated operational risk management personnel, the status of the risk profile may become Complete.

A risk profile may also be created for a plurality of functional risk areas of a business unit instead of or in addition to creating a risk profile for one or more loss event types, such as Basel Level 2 loss event types and/or Basel Level 1 loss event types. Exemplary functional risk areas for which a risk profile may be create may include loss management, technology, human capital, business process, vendor, financial, real estate, fiduciary, legal, compliance, business continuity planning and change management. The process for creating a risk profile for one or more functional risk areas would be similar to the process of creating a risk profile for one or more loss event types. For example, the process may include assigning a control environment rating and/or a residual risk rating to one or more functional risk areas, as described above.

While embodiments of the present invention have been described above, it is to be understood that any and all equivalent realizations of the present invention are included within the scope and spirit thereof. Thus, the embodiments depicted are presented by way of example only and are not intended as limitations upon the present invention. While particular embodiments of the invention have been described and shown, it will be understood by those of ordinary skill in this art that the present invention is not limited thereto since many modifications can be made. Therefore, it is contemplated that any and all such embodiments are included in the present invention as may fall within the literal or equivalent scope of the appended claims.

In addition, as mentioned above, the techniques described herein are not limited to any particular hardware or software configuration; they may find applicability in any computing or processing environment. The techniques may be implemented in hardware or software, or a combination of the two. Preferably, the techniques are implemented in computer programs and/or processes executing on programmable computers that each include a processor, a storage medium readable by the processor (including volatile and non-volatile memory and/or storage elements), at least one input device, and one or more output devices.

Each program or process is preferably implemented in high level procedural or object oriented programming language to communicate with a computer system. However, the programs can be implemented in assembly or machine language, if desired. In any case the language may be compiled or interpreted language.

Each such computer program is preferably stored on a storage medium or device (e.g., CD-ROM, hard disk, or magnetic disk) that is readable by a general or special purpose programmable computer for configuring and operating the computer when the storage medium or device is read by the computer to perform the procedures described herein. The system may also be considered to be implemented as a computer-readable storage medium, configured with a computer program, where the storage medium so configured causes a computer to operate in a specific and predefined manner.

Other embodiments are within the scope of the following claims.

What is claimed is:

1. A computer-based method for creating a risk profile for a business unit of an enterprise for managing operational risk, comprising:
assessing a plurality of first level operational loss event types for a business unit of an enterprise;
determining a first control environment rating for one or more of the plurality of assessed first level operational loss event types responsive to the assessment of the one or more first level operational loss event types; and
determining a first residual risk rating for one or more of the plurality of assessed first level operational loss event types responsive to the assessment of the one or more first level operational loss event types.

2. The method of claim 1, further comprising the step of storing the determined first control environment ratings and the determined first residual environment ratings.

3. The method of claim 1, wherein the step of assessing a plurality of first level operational loss event types for a business unit of an enterprise is comprised of:
determining a workshop results rating for one or more of the plurality of assessed first level operational loss event types responsive to the assessment of the one or more first level operational loss event types.

4. The method of claim 1, wherein the step of assessing a plurality of first level operational loss event types for a business unit of an enterprise is comprised of:
determining a loss history rating for one or more of the plurality of assessed first level operational loss event types responsive to the assessment of the one or more first level operational loss event types.

5. The method of claim 1, wherein the step of assessing a plurality of first level operational loss event types for a business unit of an enterprise is comprised of:
determining an issues rating for one or more of the plurality of assessed first level operational loss event types responsive to the assessment of the first level one or more operational loss event types.

6. The method of claim 1, wherein the step of assessing a plurality of first level operational loss event types for a business unit of an enterprise is comprised of:
determining a risk assessment rating for one or more of the plurality of assessed first level operational loss event types responsive to the assessment of the one or more first level operational loss event types.

7. The method of claim 3, wherein the workshop results rating is based on one or more ratings selecting from the group consisting of a loss history rating, an issues rating and a risk assessment rating.

8. The method of claim 1, wherein the step of assessing a plurality of first level operational loss event types for a business unit of an enterprise is comprised of:
determining a scenario analysis rating for one or more of the plurality of assessed first level operational loss event types responsive to the assessment of the one or more first level operational loss event types.

9. The method of claim 1, wherein the step of assessing a plurality of first level operational loss event types for a business unit of an enterprise is comprised of:
determining a customer impact rating for one or more of the plurality of assessed first level operational loss event types responsive to the assessment of the one or more first level operational loss event types.

10. The method of claim 1, wherein the step of assessing a plurality of first level operational loss event types for a business unit of an enterprise is comprised of:
determining an reputational impact rating for one or more of the plurality of assessed first level operational loss event types responsive to the assessment of the first level one or more operational loss event types.

11. The method of claim 1, wherein the step of assessing a plurality of first level operational loss event types for a business unit of an enterprise is comprised of:
determining an external loss data rating for one or more of the plurality of assessed first level operational loss event types responsive to the assessment of the first level one or more operational loss event types.

12. The method of claim 1, further comprising:
assessing a plurality of second level operational loss event types for a business unit of an enterprise based on the assessment of the one or more first level operational loss event types;
determining a second control environment rating for one or more of the plurality of assessed second level operational loss event types responsive to the assessment of the one or more first level operational loss event types; and
determining a second residual risk rating for one or more of the plurality of assessed second level operational loss event types responsive to the assessment of the one or more first level operational loss event types.

13. The method of claim 1, further comprising the step of storing the determined second control environment ratings and the determined second residual environment ratings.

14. The method of claim 12, wherein each of the first level operational loss event types is a subtype of one of the second level operational loss events types.

15. The method of claim 1, wherein the first level operational loss event types are selected from the group consisting of unauthorized activity; theft and fraud; system security; employee relations; environment; diversity and discrimination; suitability, disclosure and fiduciary; improper business or market practices; product flaws; selection, sponsorship and exposure; advisory activities; disaster and other events; systems; transaction capture, execution and maintenance; customer intake and documentation; customer/client account management; trade counterparties; and vendors and suppliers.

16. The method of claim 12, wherein the second level operational loss event types are selected from the group consisting of internal fraud; external fraud; employment practices and workplace safety; clients, products and business practices; damage to physical assets; business disruption and system failures; and execution delivery and process management.

17. The method of claim 1, further comprising the step of creating a control environment matrix for one or more of the plurality of first level operational loss event types responsive to the assessment of the plurality of first level operational loss event types.

18. The method of claim 1, further comprising the step of creating a residual risk matrix for one or more of the plurality of first level operational loss event types responsive to the assessment of the plurality of first level operational loss event types.

19. The method of claim 1, wherein the business unit is selected from the group consisting of capital management, general banking, corporate investment banking, wealth management, finance, human resources, technology, operations, ecommerce and other.

20. The method of claim 1, wherein the first residual risk rating for one or more of the plurality of assessed first level operational loss event types is determined responsive to the first control environment rating.

21. A computer-based method for creating a risk profile for a business unit of an enterprise for managing operational risk, comprising:
assessing a plurality of functional risk areas for a business unit of an enterprise;
determining a control environment rating for one or more of the plurality of assessed functional risk areas responsive to the assessment of the one or more functional risk areas; and
determining a residual risk rating for one or more of the plurality of assessed functional risk areas responsive to the assessment of the one or more functional risk areas.

22. The method of claim 21, wherein the functional risk area is selected from the group consisting of loss management, technology, human capital, business process, vendor, financial, real estate, fiduciary, legal, compliance, business continuity planning and change management.

23. A computer readable medium containing a computer software for creating a risk profile for a business unit of an enterprise, the computer software comprising program instructions that:
assess a plurality of first level operational loss event types for a business unit of an enterprise;
determine a first control environment rating for one or more of the plurality of assessed first level operational loss event types responsive to the assessment of the one or more first level operational loss event types; and
determine a first residual risk rating for one or more of the plurality of assessed first level operational loss event types responsive to the assessment of the one or more first level operational loss event types.

24. A computer based system for creating a risk profile for a business unit of an enterprise, comprising:
a first user interface for assessing a plurality of first level operational loss event types for a business unit of an enterprise;
a second user interface for determining a first control environment rating for one or more of the plurality of assessed first level operational loss event types responsive to the assessment of the one or more first level operational loss event types;
a third user interface for determining a first residual risk rating for one or more of the plurality of assessed first level operational loss event types responsive to the assessment of the one or more first level operational loss event types; and
a database for storing the first control environment rating information and the first residual environment rating information.

25. A data structure configured to operate with a computer program for storing an operational risk profile for a business unit, the data structure comprising:
a first data element, wherein the first data element represents a control environment rating for a plurality of first level operational loss event types for a business unit; and
a second data element, wherein the second data element represents a residual risk rating for a plurality of first level operational loss event types for the business unit.

26. A user interface for creating a risk profile for a business unit of an enterprise, comprising:
a first area for assessing a plurality of first level operational loss event types for a business unit of an enterprise;
a second area for determining a first control environment rating for one or more of the plurality of assessed first level operational loss event types responsive to the assessment of the one or more first level operational loss event types; and
a third area for determining a first residual risk rating for one or more of the plurality of assessed first level operational loss event types responsive to the assessment of the one or more first level operational loss event types.
